(19) United States
(12) Patent Application Publication
(10) Pub. No.: US 2022/0109822 A1
(43) Pub. Date: Apr. 7, 2022

(54) MULTI-SENSOR CAMERA SYSTEMS, DEVICES, AND METHODS FOR PROVIDING IMAGE PAN, TILT, AND ZOOM FUNCTIONALITY

(71) Applicant: Facebook Technologies, LLC, Menlo Park, CA (US)

(72) Inventors: Howard William Winter, Southampton (GB); Gabriel Molina, Sunnyvale, CA (US); Stephen Mark Jeapes, Cambridge (GB); Nan Jiang, Palo Alto, CA (US); Anthony Dodero, Mountain View, CA (US); John Kramer, Greenwood Village, CO (US); Honghong Peng, Mountain View, CA (US); Jesse Tyler Walton, Emeryville, CA (US); Andrea Colaco, Los Altos, CA (US); Joseph Moak, San Carlos, CA (US); Rex Crossen, Oakland, CA (US); Josiah Vincent Vivona, Poway, CA (US)

(21) Appl. No.: 17/475,445

(22) Filed: Sep. 15, 2021

Related U.S. Application Data
(60) Provisional application No. 63/086,980, filed on Oct. 2, 2020.
(60) Provisional application No. 63/132,982, filed on Dec. 31, 2020.

(51) Int. Cl. H04N 13/282; H04N 13/106

(52) U.S. Cl. CPC H04N 13/282; G06F 3/011; H04N 13/106

(57) ABSTRACT

The disclosed camera system may include a primary camera and a plurality of secondary cameras that each have a maximum horizontal FOV that is less than a maximum horizontal FOV of the primary camera. Two of the plurality of secondary cameras may be positioned such that their maximum horizontal FOVs overlap in an overlapped horizontal FOV and the overlapped horizontal FOV may be at least as large as a minimum horizontal FOV of the primary camera. The camera system may also include an image controller that simultaneously activates two or more of the primary camera and the plurality of secondary cameras when capturing images from a portion of an environment included within the overlapped horizontal FOV. Various other systems, devices, assemblies, and methods are also disclosed.

### CROSS REFERENCE TO RELATED APPLICATION

This application claims the benefit of priority to U.S. Provisional Application No. 63/086,980, filed Oct. 2, 2020, and U.S. Provisional Application No. 63/132,982, filed Dec. 31, 2020, the disclosures of each of which are incorporated herein, in their entirety, by this reference.

### BRIEF DESCRIPTION OF APPENDICES

The accompanying drawings illustrate a number of exemplary embodiments and are a part of the specification. Together with the following description, these drawings demonstrate and explain various principles of the present disclosure.

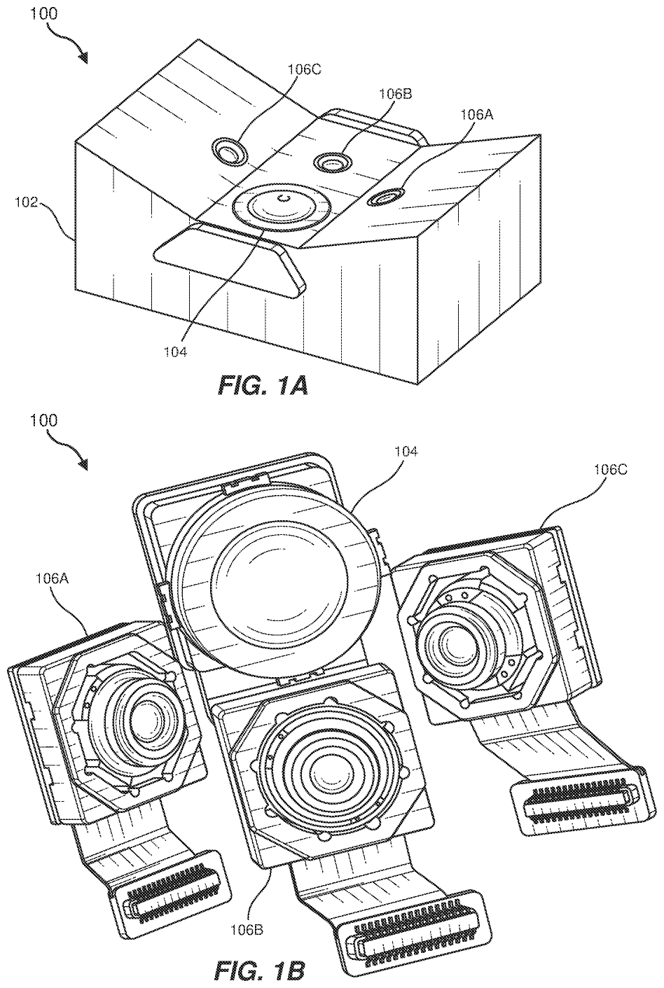

FIG. 1A shows an exemplary virtual PTZ camera device that includes multiple cameras according to embodiments of this disclosure.

FIG. 1B shows components of the exemplary virtual PTZ camera device shown in FIG. 1A according to embodiments of this disclosure.

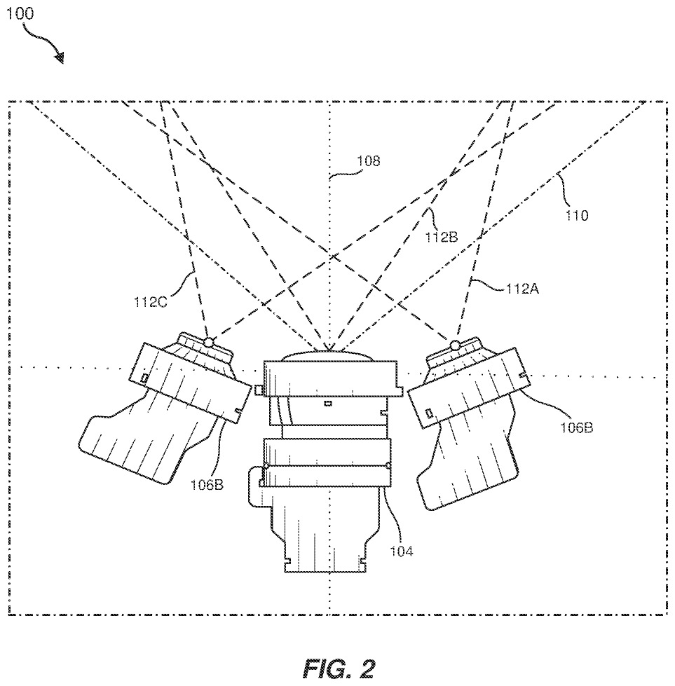

FIG. 2 shows exemplary horizontal fields-of-view (FOVs) of cameras of the virtual PTZ camera device shown in FIGS. 1A and 1B according to embodiments of this disclosure.

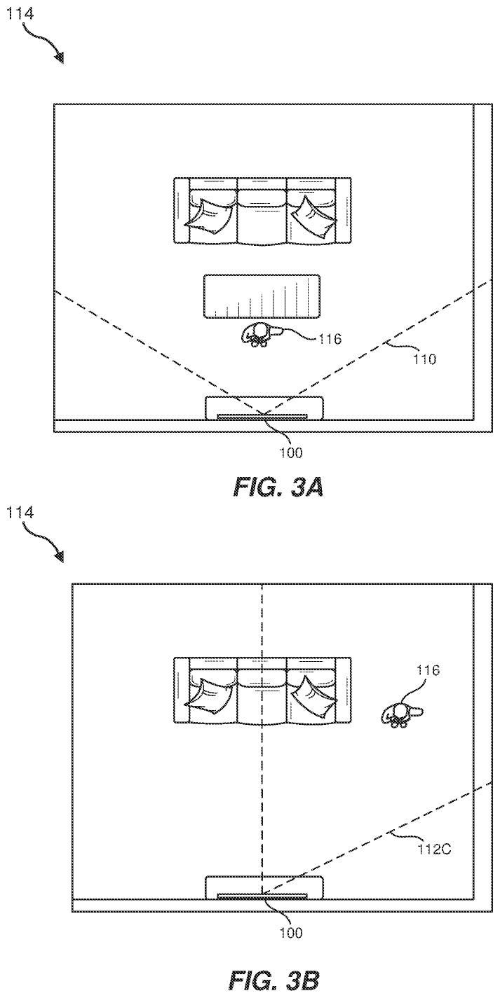

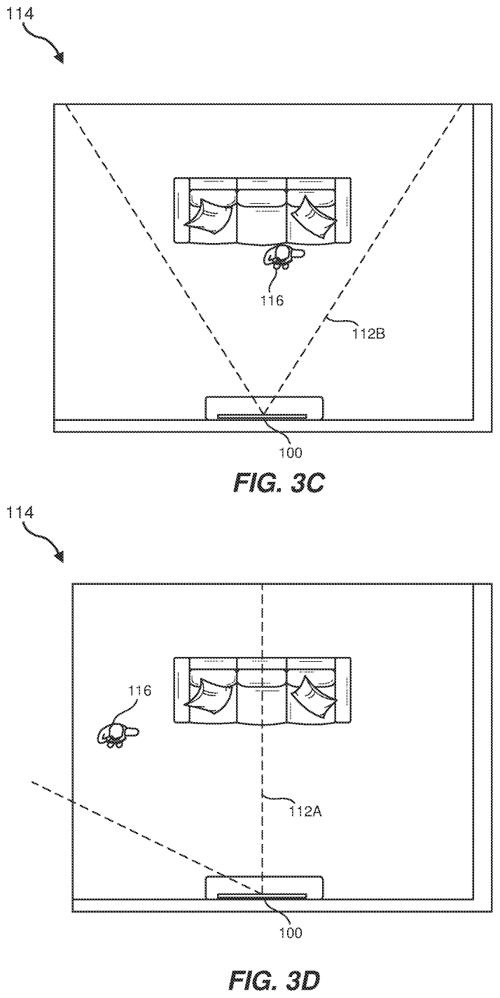

FIG. 3A shows a horizontal FOV of a primary camera of an exemplary virtual PTZ camera device according to embodiments of this disclosure.

FIG. 3B shows a horizontal FOV of a secondary camera of the exemplary virtual PTZ camera device of FIG. 3A according to embodiments of this disclosure.

FIG. 3C shows a horizontal FOV of a secondary camera of the exemplary virtual PTZ camera device of FIG. 3A according to embodiments of this disclosure.

FIG. 3D shows a horizontal FOV of a secondary camera of the exemplary virtual PTZ camera device of FIG. 3A according to embodiments of this disclosure.

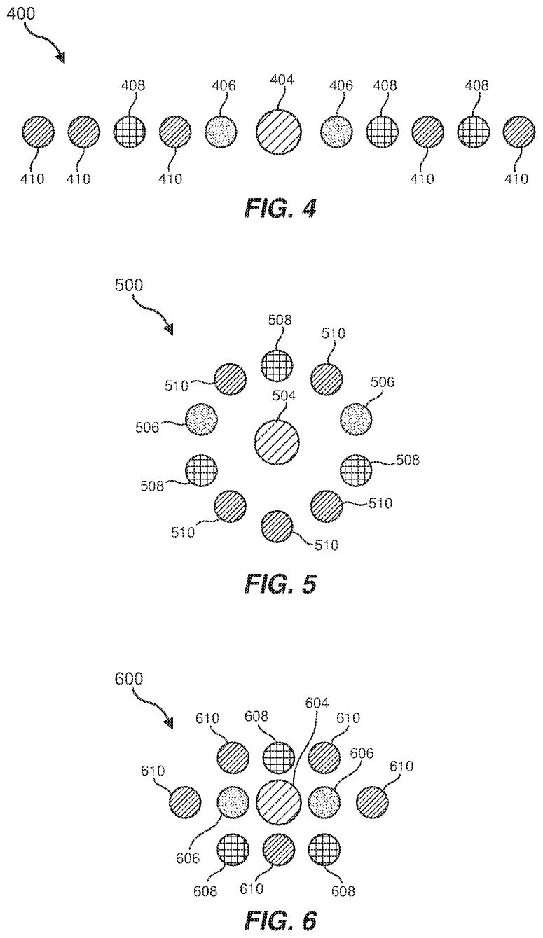

FIG. 4 illustrates a physical lens layout in an exemplary virtual PTZ camera system according to embodiments of this disclosure.

FIG. 5 illustrates a physical lens layout in an exemplary virtual PTZ camera system according to embodiments of this disclosure.

FIG. 6 illustrates a physical lens layout in an exemplary virtual PTZ camera system according to embodiments of this disclosure.

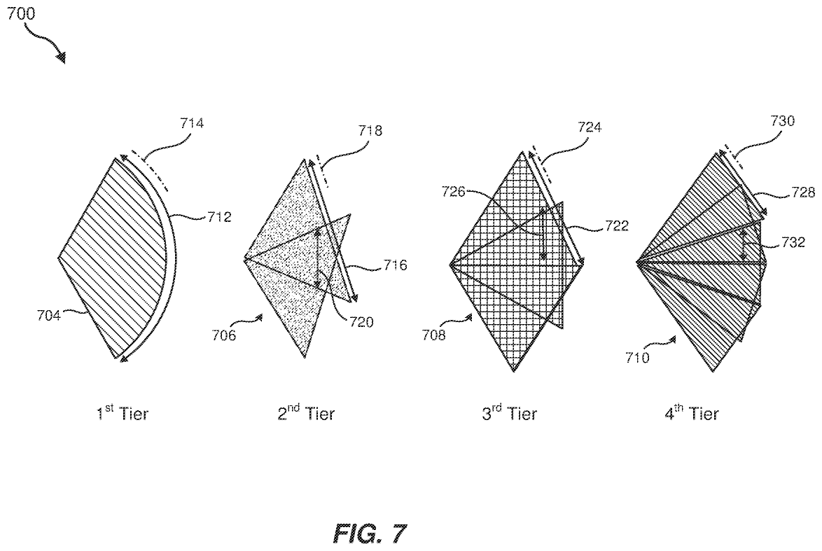

FIG. 7 shows partially overlapping horizontal FOVs of sensors in a tiered multi-sensor camera system according to embodiments of this disclosure.

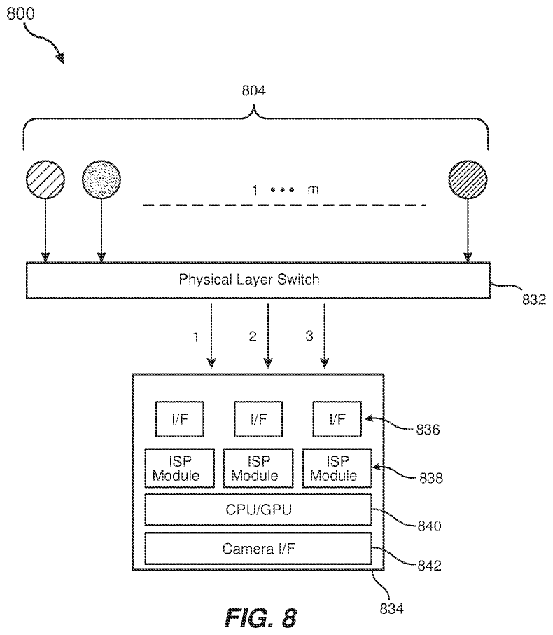

FIG. 8 shows an exemplary tiered multi-sensor camera system that include multiple sensors connected to various computing devices according to embodiments of this disclosure.

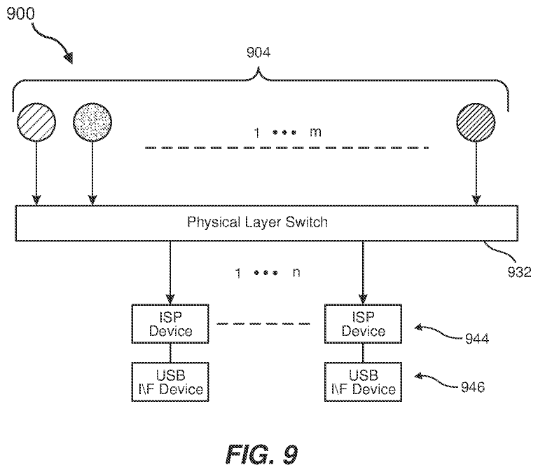

FIG. 9 shows an exemplary tiered multi-sensor camera system that include multiple sensors connected to various computing devices according to embodiments of this disclosure.

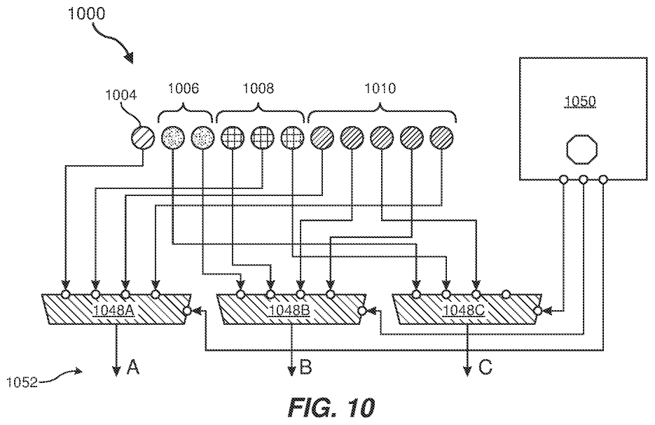

FIG. 10 shows an exemplary tiered multi-sensor camera system that include multiple sensors connected to various computing devices according to embodiments of this disclosure.

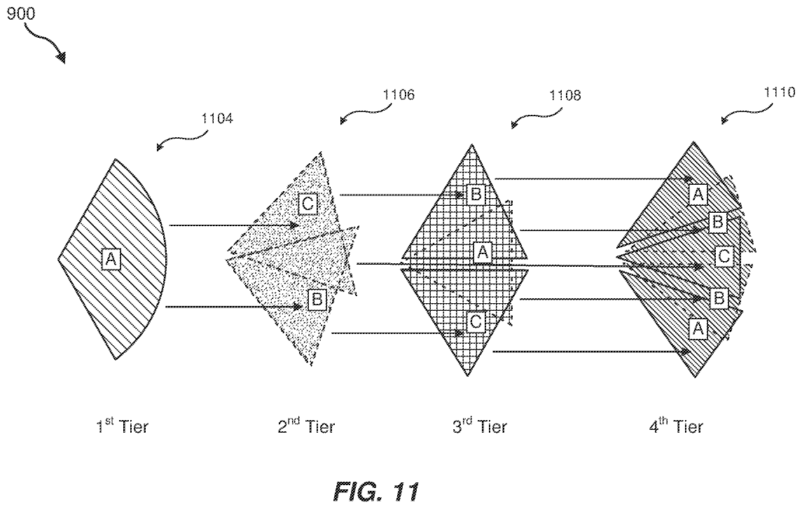

FIG. 11 shows designated data output channels of camera sensors in a tiered multi-sensor camera system according to embodiments of this disclosure.

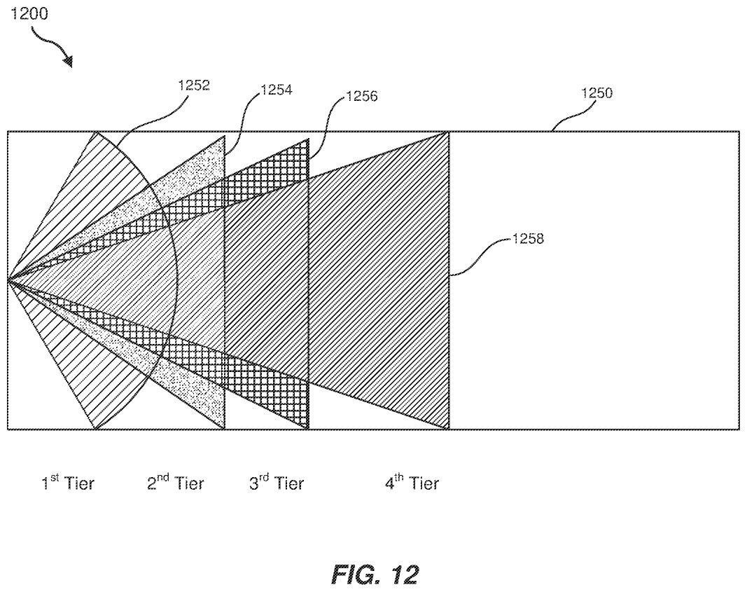

FIG. 12 shows overall FOVs of sensor tiers in a tiered multi-sensor camera system according to embodiments of this disclosure.

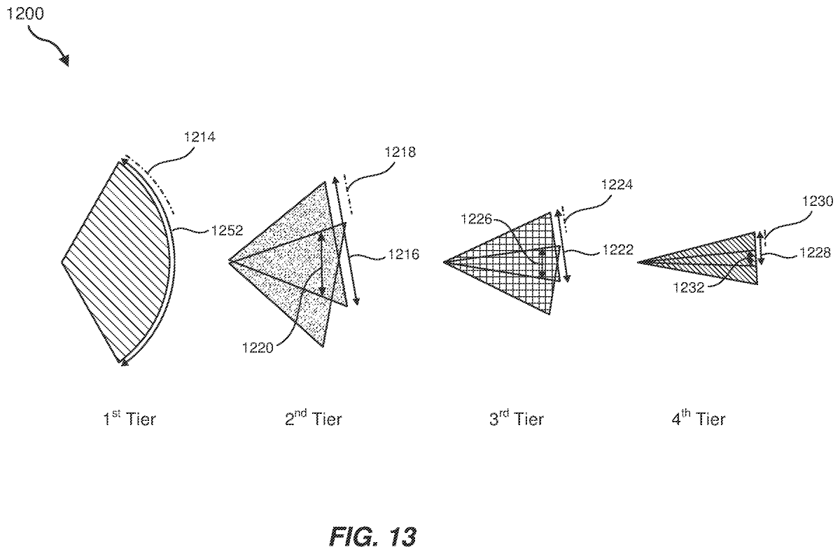

FIG. 13 shows partially overlapping horizontal FOVs of sensors in a tiered multi-sensor camera system according to embodiments of this disclosure.

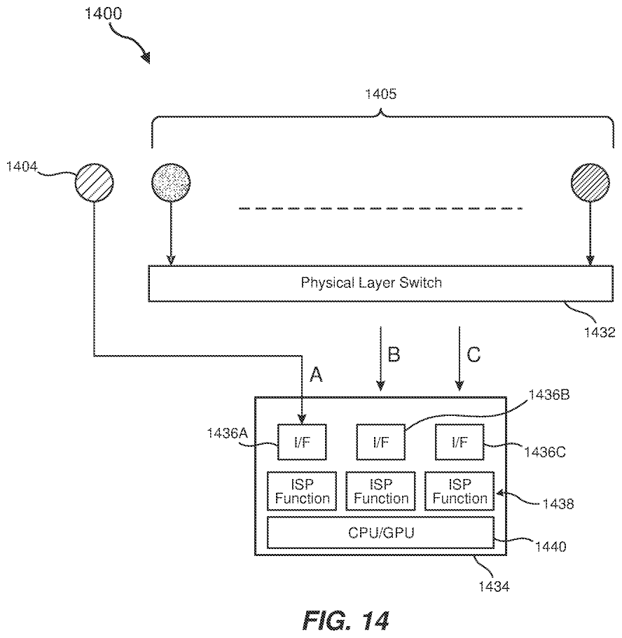

FIG. 14 shows an exemplary tiered multi-sensor camera system that include multiple sensors connected to various computing devices according to embodiments of this disclosure.

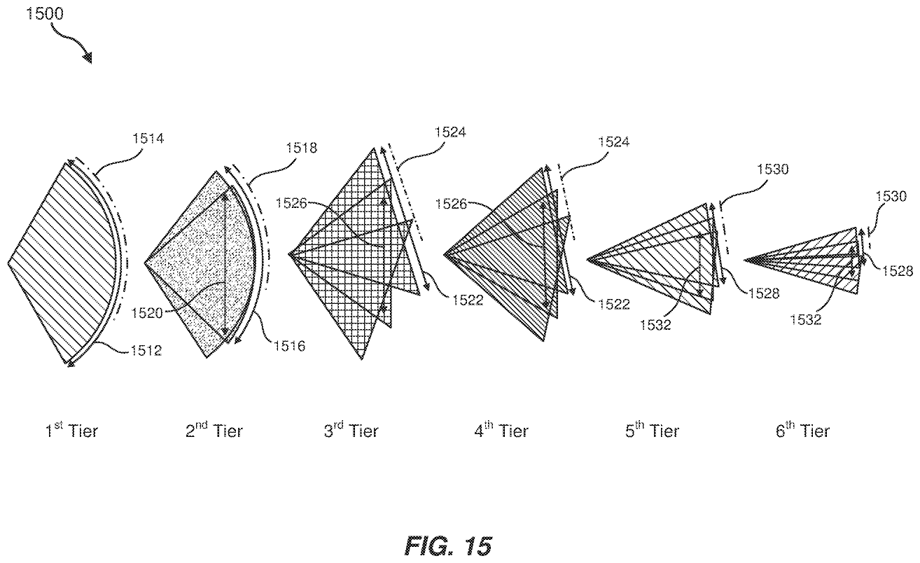

FIG. 15 shows partially overlapping horizontal FOVs of sensors in a tiered multi-sensor camera system providing ultra-high-definition images according to embodiments of this disclosure.

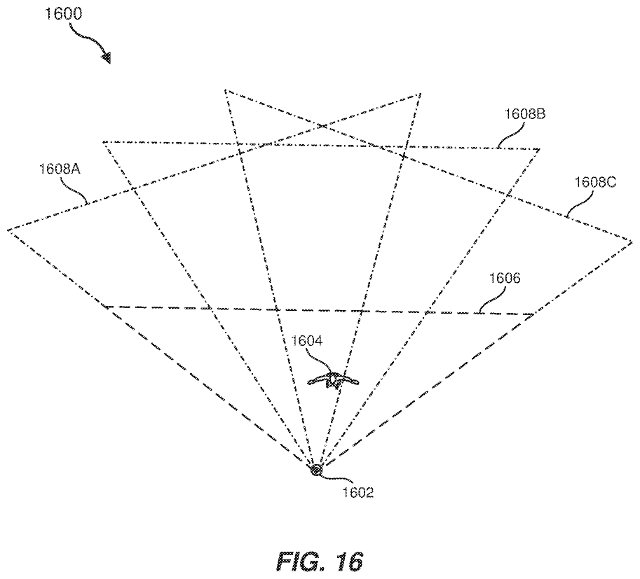

FIG. 16 shows horizontal FOVs of cameras of an exemplary virtual PTZ camera device according to embodiments of this disclosure.

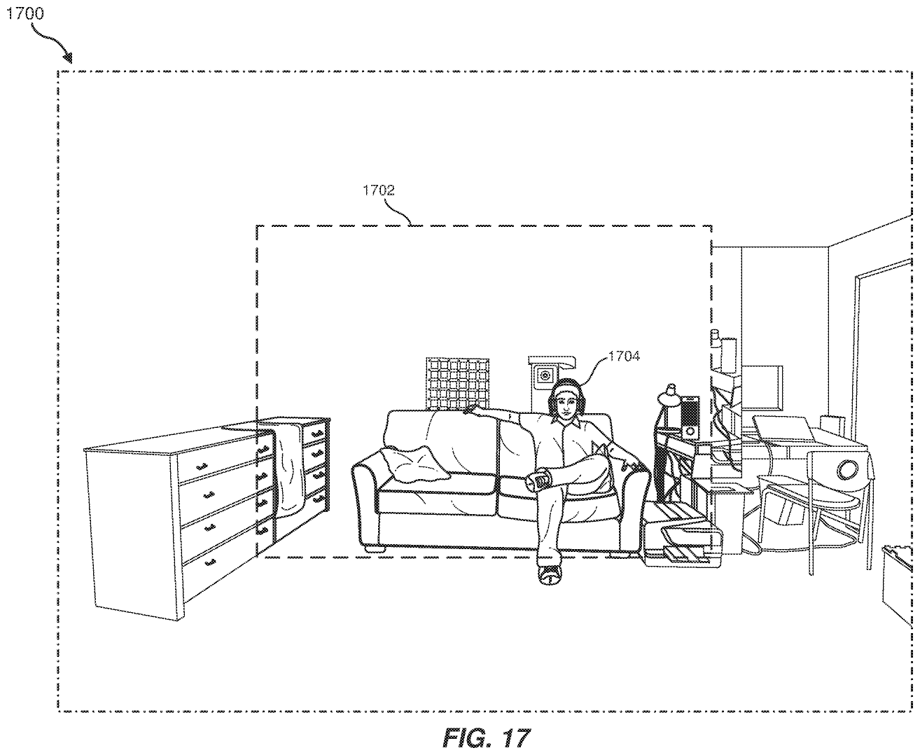

FIG. 17 shows views of cameras of an exemplary virtual PTZ camera device according to embodiments of this disclosure.

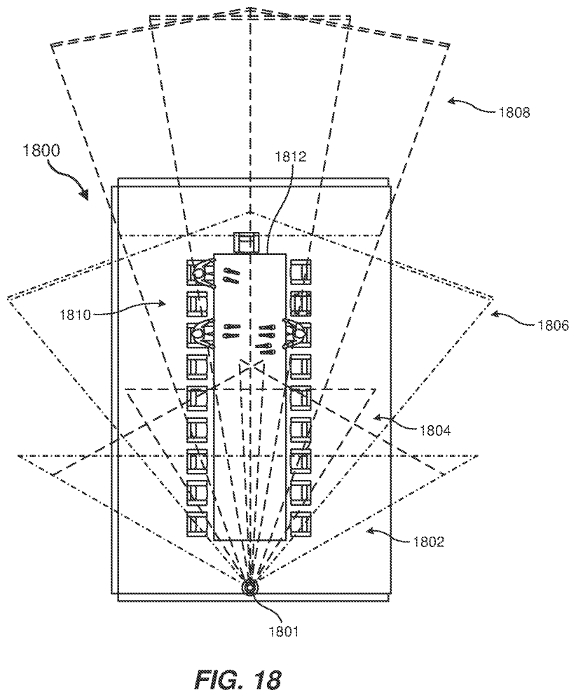

FIG. 18 shows horizontal FOVs of cameras of an exemplary virtual PTZ camera device according to embodiments of this disclosure.

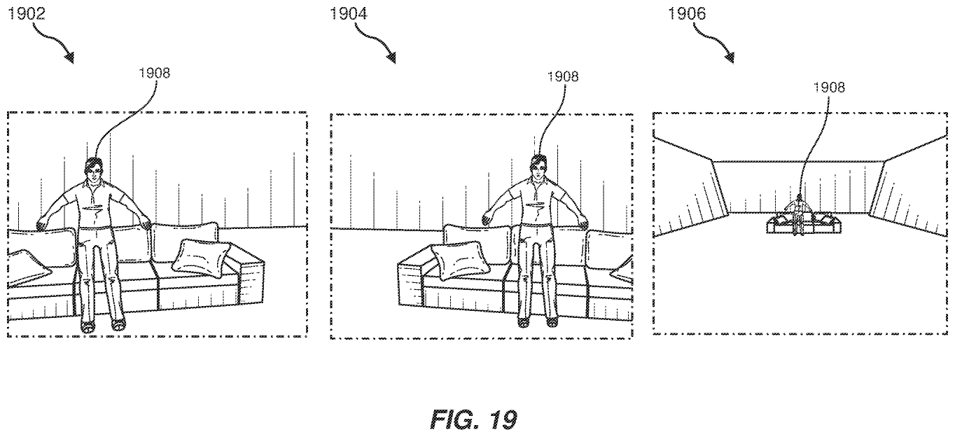

FIG. 19 shows views of cameras of an exemplary virtual PTZ camera device according to embodiments of this disclosure.

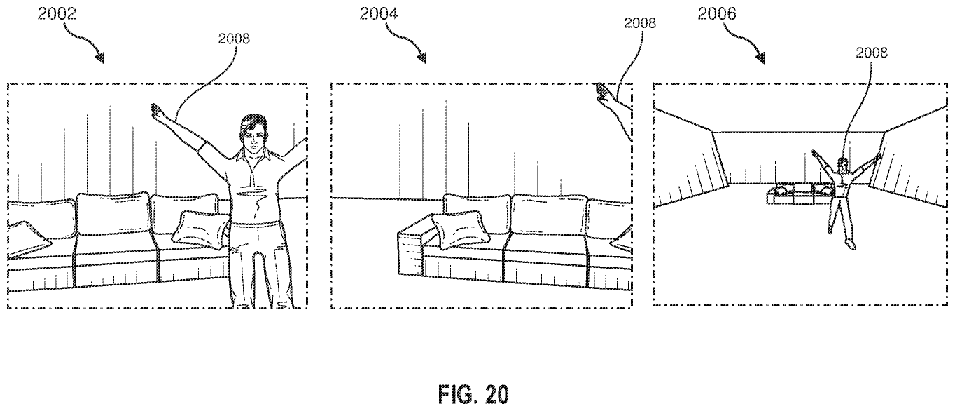

FIG. 20 shows views of cameras of an exemplary virtual PTZ camera device according to embodiments of this disclosure.

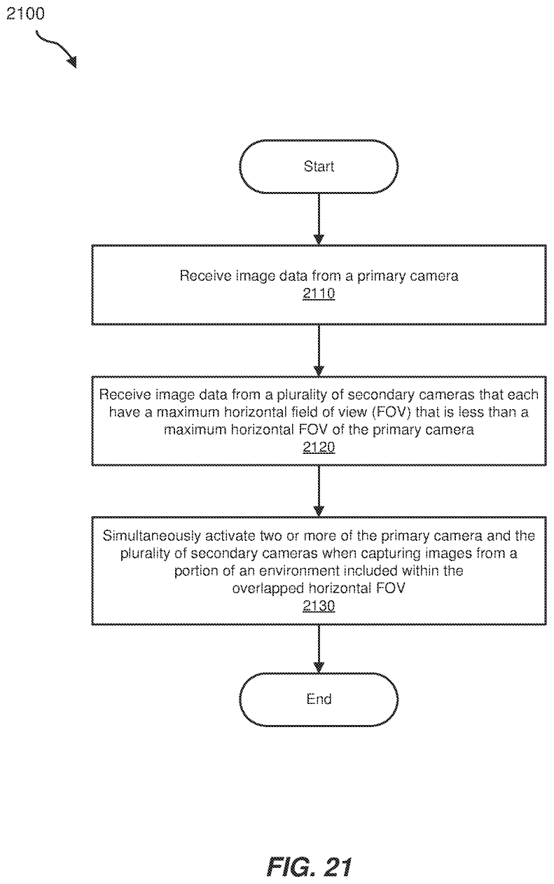

FIG. 21 is a flow diagram of an exemplary method for operating a virtual PTZ camera system in accordance with embodiments of this disclosure.

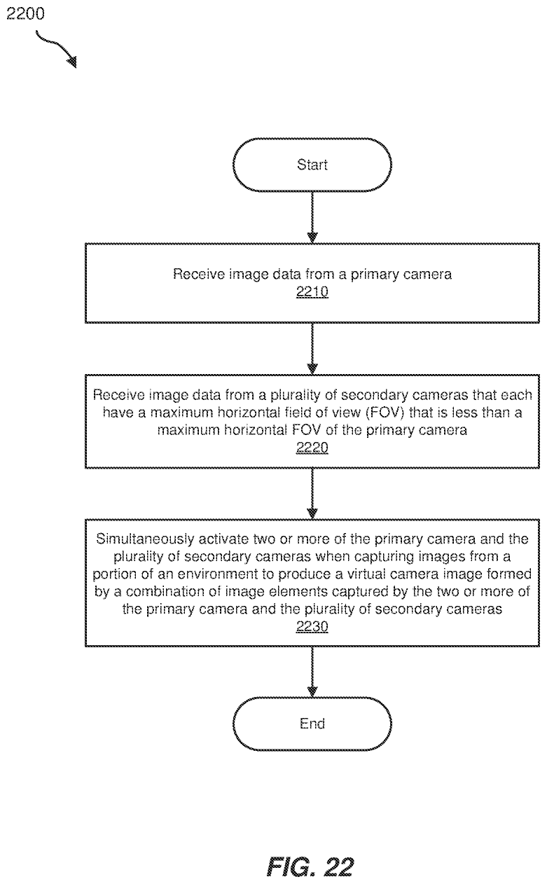

FIG. 22 is a flow diagram of an exemplary method for operating a virtual PTZ camera system in accordance with embodiments of this disclosure.

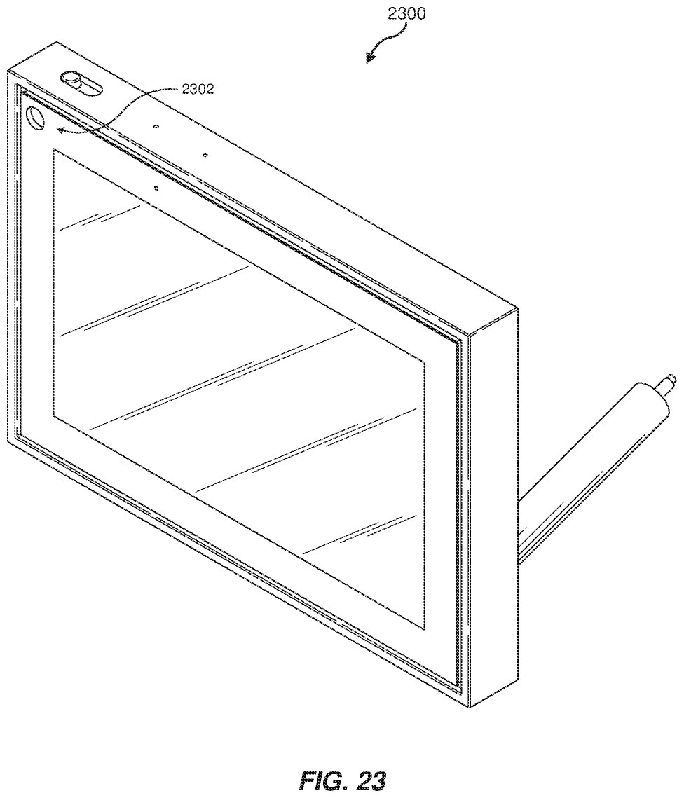

FIG. 23 shows an exemplary display system according to embodiments of this disclosure.

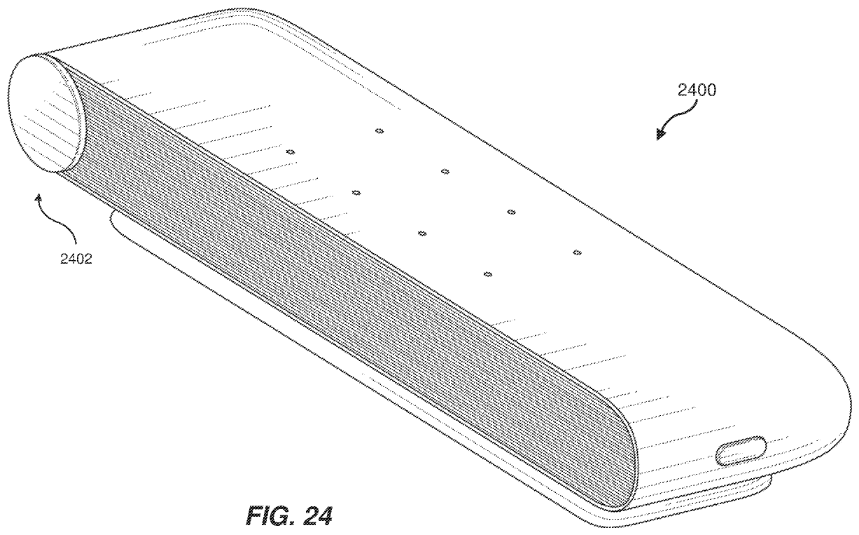

FIG. 24 shows an exemplary camera system according to embodiments of this disclosure.

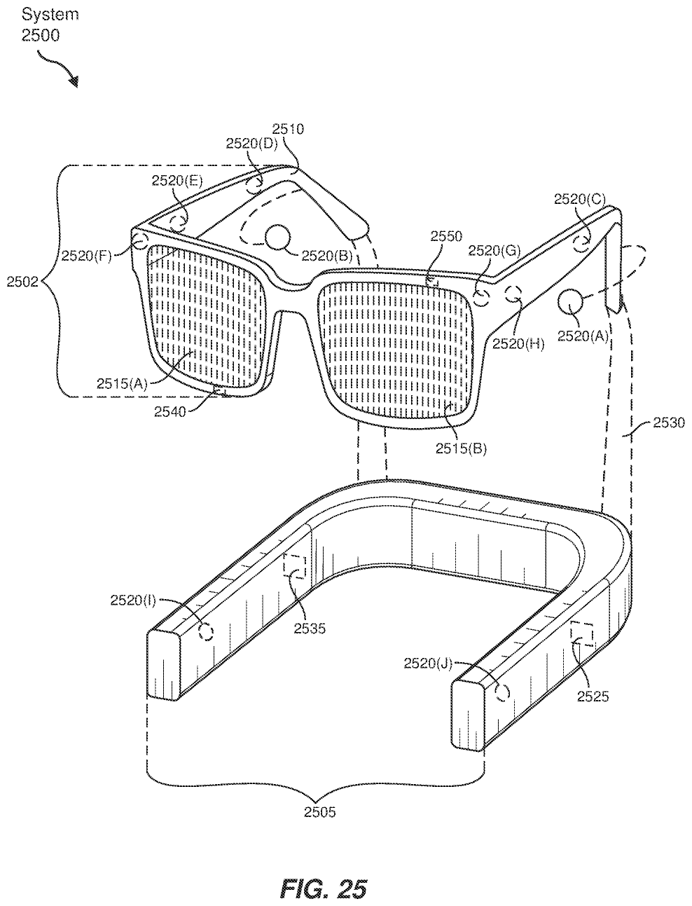

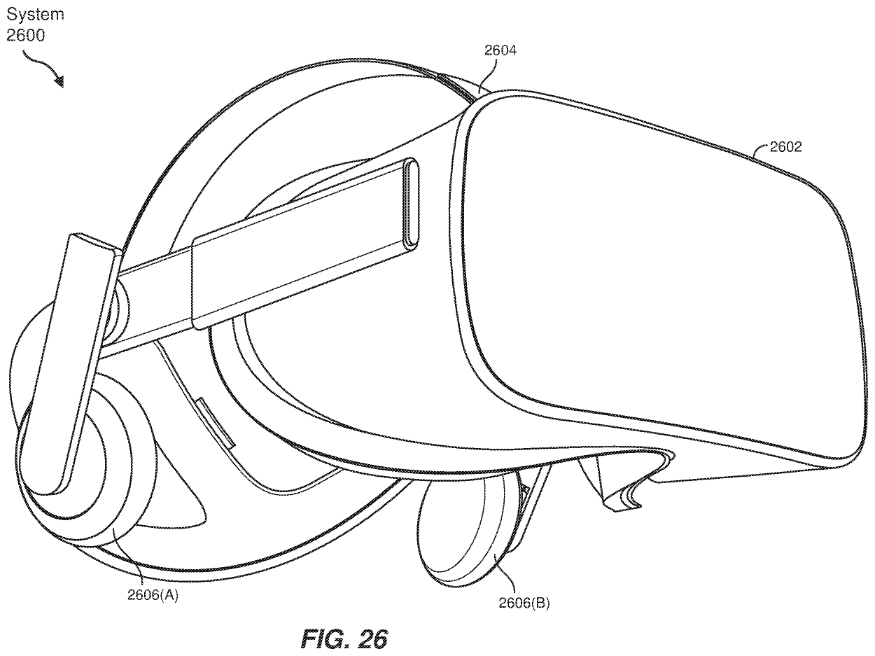

FIG. 25 is an illustration of exemplary augmented-reality glasses that may be used in connection with embodiments of this disclosure.

FIG. 26 is an illustration of an exemplary virtual-reality headset that may be used in connection with embodiments of this disclosure.

Throughout the drawings and appendices, identical reference characters and descriptions may indicate similar, but not necessarily identical, elements. While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION OF EXEMPLARY EMBODIMENTS

Pan-tilt-zoom (PTZ) cameras are increasingly utilized in a variety of environments because they are capable of providing good coverage of a room and can typically provide 10-20× optical zoom. However, existing PTZ cameras are commonly bulky, heavy, and operationally complex, relying on moving parts to provide required degrees of freedom for use in various contexts. Thus, it would be beneficial to achieve effective results similar those obtained with conventional PTZ cameras while reducing the complexity and size of the camera devices.

The present disclosure is generally directed to multi-sensor camera devices (i.e., virtual PTZs) that provide pan, tilt, and zoom functionality in a reduced size article that does not utilize moving mechanical parts to achieve various levels of zoom. In some embodiments, the disclosed PTZ approach may use a large number of image sensors with overlapping horizontal fields of view arranged in tiers. The image sensors and corresponding lenses utilized in the systems described herein may be significantly smaller than conventional image sensors and lenses. Each tier may, for example, have increasingly more sensors with narrowing fields of view. A mixture of digital and fixed optical zoom positions utilized in the disclosed systems may provide high-resolution coverage of an environmental space at a variety of positions. Multiplexing/switching at an electrical interface may be used to connect a large number of sensors to system on a chip (SOC) or universal serial bus (USB) interface devices. Position aware n from m selection of sensors may be used to select a current sensor used to provide a displayed image and to prepare the next left or right and/or zoom in or out sensor.

SOC devices used in camera applications typically support up to 3 or 4 images sensors, so building a camera capable of directly connecting to a larger number of sensors would typically not be feasible without a custom application specific integrated circuit (ASIC) and/or field programmable gate array (FPGA). However, such a setup would likely be inefficient and unsuitable for use in high-speed interfaces and replication of logical functions. Additionally, such ASICs can be relatively expensive, making them impractical for implementation in many scenarios. Single sensor interfaces also tend to be overly time-consuming and impractical for use in switching between camera sensors in a practical manner (e.g., due to delays from electrical interface initialization, sensor setup, white balance, etc.), resulting in undesirable image stalling and/or corruption during switching.

However, in the disclosed embodiments discussed below, it may not be necessary for all sensors to be active at the same time as a camera view pans and/or zooms around and captures different portions of a scene. Rather, only the current active sensor(s) may be required at any one position and time for image capture, and image sensors that might be utilized next due to proximity may also be turned on and ready to go. In one embodiment, a small number (n) of active sensors from the total number (m) sensors may be selected. For example, the active sensors utilized at a particular time and position may include a currently used sensor (i.e., the sensor actively capturing an image in the selected FOV), the next left or right sensor, and/or the next zoom in or out sensor. Selection may be based on various factors, including the current position of the virtual PTZ camera. In some examples, movement of the camera view may be relatively slow, allowing for the switching sensor latency (e.g., approximately 1-2 seconds) to be effectively hidden.

Virtual PTZ camera pan and tilt ranges might be excessive when the FOV is focused deeper into a room or space. In some embodiments, each tier of sensors in the camera can narrow down its total FOV so as to reduce the number of lenses and improve angular resolution. Multiple tiers may each be optimized for part of the zoom range to allow fixed focus lenses to be optimized. A 90-degree rotation of the image sensors (e.g., between landscape and portrait modes) for later tiers may provide higher vertical FOV, which may help avoid overlapping in the vertical plane. Using a fisheye lens in the primary tier may provide a wider overall FOV than conventional PTZs. Additionally, the fisheye lens may be used to sense objects/people to direct the framing and selection of image sensors in other tiers corresponding to higher levels of zoom.

FIGS. 1A-2 illustrate an exemplary virtual PTZ camera system 100 having at least two tiers of sensors with partially overlapping horizontal FOVs of sensors, in accordance with some embodiments. In the virtual PTZ camera system 100 shown, four cameras may be placed in close proximity to each other. For example, a primary camera 104 (i.e., a first-tier camera) may be disposed in a central position within housing 102. Primary camera 104 may include, for example, a wide-angle lens (e.g., a fisheye lens) and a sensor to capture image data from an environment. Secondary cameras 106A, 106B, and 106C (i.e., second tier cameras) may also be disposed in housing 102 at locations near primary camera 104. For example, as shown in FIGS. 1A and 1B, secondary camera 106A may be disposed on one side of primary camera 104, secondary camera 106C may be disposed on an opposite side of primary camera 104, and secondary camera 106B may be disposed below primary camera 104. Secondary cameras 106A, 106B, and 106C may also be disposed in any other suitable location. Additionally or alternatively, secondary cameras 106A, 106B, and/or 106C, and/or any other suitable cameras, may be located separately from housing 102. In various embodiments, secondary cameras 106A-106C may each include a separate lens and sensor, with each respective combination of lens and sensor having a greater focal length than primary camera 104 so as to provide a greater zoom power than primary camera 104, thus providing a greater level of detail and resolution of various portions of an environment in a narrower FOV.

As discussed in greater detail below, secondary cameras 106A-106C may cover a range of an environment that partially or fully overlaps a portion of the environment captured by primary camera 104, with secondary cameras 106A-106C covering adjacent regions having FOVs that partially overlap to provide combined coverage of a region. In some examples, primary camera 104 and one or more of secondary cameras 106A, 106B, and 106C may have optical axes that are oriented parallel or substantially parallel to each other, with the respective camera lenses aligned along a common plane.

In certain examples, as shown in FIGS. 1A and 2, one or more lenses may have optical axes that are tilted with respect to each other. For example, secondary cameras 106A and 106C may be angled inward to a selected degree toward primary camera 104, with secondary camera 106B oriented parallel or substantially parallel to primary camera 104. As shown in FIG. 2, secondary cameras 106A and 106C may be oriented inward to ensure, for example, that a desired framing of a subject, such as a human torso, fully fits within both the FOVs of neighbouring cameras as long as the subject is beyond a certain distance away from the cameras. This condition provides, for example, that in a transition zone between FOVs, both secondary cameras 106A and 106C may have sufficient available data to fuse a synthesized view as described herein. As shown in FIG. 2, secondary cameras 106A, 106B, and 106C may have respective horizontal FOVs 112A, 112B, and 112C that partially overlap each other as well as overlapping wide-angle FOV 110 of primary camera 104. As can be seen in this figure, secondary cameras 106A and 106C are tilted inward toward each other and primary camera 104 so that the optical axes of secondary cameras 106A and 106C are not parallel to optical axis 108 of primary camera 104.

FIGS. 3A-3D illustrate regions of an exemplary environment that may be captured by a multicamera system, such as virtual PTZ camera system 100 illustrated in FIGS. 1A-2. As shown, virtual PTZ camera system 100 may be positioned and configured to capture images from portions of an environment 114, particularly portions of environment 114 including one or more subjects, such as individual 116 located within environment 114. The subjects may be detected and framed within captured images automatically and/or manually based on user input. As shown in FIG. 3A, a maximum horizontal FOV 110 of primary camera 104 may have a wide-angle that covers a significant portion of environment 114. As shown in FIGS. 3B-3D, secondary cameras 106A-C of virtual PTZ camera system 100 may have smaller horizontal FOVs 112A-C that each cover less of environment 114 than primary camera 104. One or more of primary camera 104 and secondary cameras 106A-C may be activated at a particular time based on the location of individual 116. For example, when individual 116 is closer to virtual PTZ camera system 100, primary camera 104 may be activated to capture images of individual 116. When individual 116 is further from virtual PTZ camera system 100 one or more of secondary cameras 106A-C may be activated to capture higher resolution images of individual 116. secondary camera 106A, secondary camera 106B, and/or secondary camera 106C may be selectively activated depending on a location of individual 116. In some examples, two or more of primary camera 104 and secondary cameras 106A-C may be activated to capture and produce images when at least a portion of individual 116 is located in an area overlapped by two or more corresponding FOVS.

In some examples, a virtual PTZ approach may use multiple sensors with at least partially overlapping horizontal FOVs arranged in multiple tiers of cameras, with each tier having increasingly more sensors with narrowing fields of view. A mixture of digital and fixed optical zoom positions may provide coverage of an environmental space at various levels of detail and scope. In some embodiments, multiplexing and/or switching at an electrical interface may be used to connect the large number of sensors to SOCs or USB interface devices. Position aware n from m selection of sensors may be used to select the current sensor and prepare the next (e.g., the nearest) left or right and/or the next zoom in or out sensor.

FIGS. 4-6 depict various exemplary virtual PTZ camera systems having multiple tiers of cameras in accordance with various embodiments. In each of these figures, physical sensors and lenses of the cameras may be laid in a variety of configurations in accordance with various embodiments. The optical axes of the cameras in each tier may be parallel or non-parallel (e.g., tilted inward toward a central camera) to provide desired degrees of coverage and overlap. In each of the illustrated layouts shown, a first-tier camera 404/504/604 having a wide-angle lens and corresponding sensor may be disposed in a central position within the array. Additional second, third, and fourth-tier sensors may be arranged around first-tier camera 404/504/604 (e.g., surrounding and/or horizontally aligned with the central lens in a generally symmetrical manner). Each of FIGS. 4, 5, and 6 show sensor arrangements for embodiments that include two sensors in the second tier, three sensors in the third tier, and five sensors in the fourth tier. Any other suitable number of cameras may be disposed in each tier in any suitable arrangement, without limitation.

For example, FIG. 4 illustrates a virtual PTZ camera system 400 having multiple tiers of cameras aligned along a single direction (e.g., a horizontal direction) with a first-tier camera 404. As shown, a pair of second-tier cameras 406 may be disposed nearest first-tier camera 404. Additionally, three third-tier cameras 408 and five fourth-tier cameras 410 may be disposed further outward from first-tier camera 404. FIG. 5 illustrates a virtual PTZ camera system 500 having multiple tiers of cameras arranged in a ring configuration around a first-tier camera 504. As shown, a pair of second-tier cameras 506, three third-tier cameras 508, and five fourth-tier cameras 510 may be arranged in a ring surrounding first-tier camera 504. FIG. 6 illustrates a virtual PTZ camera system 600 having multiple tiers of cameras arranged around a first-tier camera 604. As shown, a pair of second-tier cameras 606, three third-tier cameras 608, and five fourth-tier cameras 610 may be arranged in a ring surrounding first-tier camera 604.

Using multiple lenses to cover the zoom range for suitable PTZ functionality may require a large number of sensors. However, sensors with smaller lenses may be significantly less expensive than larger sensors used in combination with larger lenses and motors (e.g., as used in conventional PTZ cameras). If sensors overlap enough for the desired image width, then images may be effectively captured without stitching images simultaneously captured by two or more adjacent sensors. The suitable amount of overlap may depend on sensor horizontal resolution and desired image width. For example, there may need to be enough overlap in the next tier to maintain the FOV in the previous tier at the desired width. In at least one example, a mixture of fisheye and rectilinear projection lenses may be utilized to meet specified FOV requirements at each tier.

FIG. 7 depicts an exemplary virtual PTZ camera system having multiple tiers of sensors with partially overlapping horizontal FOVs of sensors according to some embodiments. As shown, for example, a virtual PTZ camera system 700 (see, e.g., virtual PTZ camera systems 400, 500, and 600 illustrated in FIGS. 4, 5, and 6) may use multiple cameras having sensors and lenses with at least partially overlapping horizontal FOVs arranged, for example, in at least four tiers, with each tier having increasingly more sensors with narrowing fields of view. A mixture of digital and fixed optical zoom positions may provide coverage of the environmental space. Multiplexing and/or switching at an electrical interface may be used to connect the large number of sensors to SOCs or USB interface devices. Position aware n from m selection of sensors may be used to select the current sensor and prepare the next (e.g., the nearest) left or right and/or the next zoom in or out sensor.

As shown in FIG. 7, virtual PTZ camera system 700 may include a first tier, a second tier, a third tier, and a fourth-tier of cameras, with each successive tier corresponding to a higher level of zoom power. Although cameras within each of the tiers may be physically positioned in close proximity to each other within camera system 700, each of the tiers are illustrated separately in FIG. 7 to better show the FOVs covered by the cameras within each tier. The first tier of camera system 700 may include a first-tier camera (e.g., first-tier camera 404/504/604 shown in FIGS. 4-6) that captures images within a first-tier camera range 704 (pictured as a wide-angle or fisheye lens range) having a maximum horizontal FOV 712 and a minimum horizontal FOV 714.

The second tier of camera system 700 may include multiple second-tier cameras, such as a pair of second-tier cameras (e.g., second-tier cameras 406/506/606 shown in FIGS. 4-6) that each capture images within a respective second-tier camera range 706 having a maximum horizontal FOV 716 and a minimum horizontal FOV 718. The second-tier cameras may be any suitable types of camera device, such as cameras having rectilinear projection lenses with fixed physical focal lengths. Additionally, the maximum horizontal FOVs of the second-tier cameras may overlap in an overlapped horizontal FOV 720.

In various embodiments, as shown, the overlapped horizontal FOV 720 of the second-tier cameras may be at least as large as the minimum horizontal FOV 714 of the first-tier camera. Accordingly, the overlapped horizontal FOV 720 may provide enough coverage for the desired image width such that images may be effectively captured by the second-tiers cameras without requiring stitching of images simultaneously captured by two or more adjacent sensors. The suitable amount of overlap may depend on sensor horizontal resolution and desired image width. For example, the overlapped horizontal FOV 720 may provide enough overlap in the second tier to maintain the FOV provided in the first tier at the desired width. As such, when the first-tier camera is digitally zoomed to capture an area corresponding to the minimum horizontal FOV 714 in a region within the maximum horizontal FOV 712, the minimum horizontal FOV 714 of the first-tier camera will be narrow enough to fit within the overlapped horizontal FOV 720 and the view may be lined up with a view captured by one or both of the second-tier cameras without requiring stitching together two or more separate views from adjacent second-tier cameras.

In one example, images captured by the first-tier camera may be utilized to produce primary images for display on a screen. An image captured by the first-tier camera may be zoomed until it is at or near the minimum horizontal FOV 714. At that point, in order to further zoom the image or increase the image resolution provided at that level of zoom, the current image feed may be switched at a point when the displayed image region captured by the first-tier camera corresponds to a region being captured by one or both of the second-tier cameras (i.e., an image of the region within a second-tier camera range 706 of one or both of the second-tier cameras). The second-tier cameras may be utilized to produce secondary images for display. In order to keep a smooth flow in the image feed prior to and following the transition between cameras, the first-tier camera and one or both of the second-tier cameras may be activated simultaneously such that the relevant first- and second-tier cameras are capturing images at the same time prior to the transition. By ensuring the displayed regions from the first- and second-tier cameras are aligned or substantially aligned prior to switching, the displayed images may be presented to a viewer with little or no noticeable impact as the images are switched from one camera to another between frames. Selection and activation of one or more of the cameras in tier 1-4 may be accomplished in any suitable manner by, for example, an image controller (see, e.g., FIGS. 8 and 9), as will be described in greater detail below.

Moreover, an image captured by two or more of the second-tier cameras, at a level of zoom corresponding to the minimum horizontal FOV 714 of the first-tier camera, may be panned horizontally between the second-tier camera ranges without stitching images captured by the second-tier cameras. This may be accomplished, for example, by activating both second-tier cameras simultaneously such that both cameras are capturing images at the same time. In this example, as an image view is panned between the two second-tier camera ranges 706 covered by respective second-tier cameras, an image feed sent to a display may be switched from an initial second-tier camera to a succeeding second-tier camera when the image covers an area corresponding to the overlapped horizontal FOV 720. Thus, rather than stitching together images or portions of images individually captured by the two second-tier cameras, the current image feed may switched at a point when the displayed image region corresponds to a region being captured by both of the second-tier cameras (i.e., an image of the region within the overlapped horizontal FOV 720). By ensuring the displayed region from the two second-tier cameras is aligned or substantially aligned prior to switching, the displayed images may be presented to a viewer with little or no noticeable impact as the images are switched from one camera to another between frames. This same technique for switching between cameras during panning and zooming may be carried out in the same or similar fashion for the third- and fourth-tier cameras in third and fourth tiers.

The third tier of camera system 700 may include multiple third-tier cameras, such as three third-tier cameras (e.g., third-tier cameras 408/508/608 shown in FIGS. 4-6) that each capture images within a respective third-tier camera range 710 having a maximum horizontal FOV 722 and a minimum horizontal FOV 724. The third-tier cameras may be any suitable types of camera device, such as cameras having rectilinear projection lenses with fixed physical focal lengths. Additionally, the maximum horizontal FOVs of adjacent third-tier cameras may overlap in overlapped horizontal FOVs 726.

In various embodiments, as shown, the overlapped horizontal FOVs 726 of adjacent third-tier cameras may be at least as large as the minimum horizontal FOV 718 of one or more of the second-tier cameras. Accordingly, the overlapped horizontal FOVs 726 may provide enough coverage for the desired image width such that images may be effectively captured by the third-tiers cameras without requiring. In one example, the overlapped horizontal FOVs 726 may each provide enough overlap in the third tier to maintain the overall FOV provided in the second tier at the desired width. As such, when a second-tier camera is digitally zoomed to capture an area corresponding to the minimum horizontal FOV 718, the minimum horizontal FOV 718 of the second-tier camera will be narrow enough to fit within a corresponding overlapped horizontal FOV 726 and the view may be lined up with a view captured by at least one of the third-tier cameras without requiring stitching together of two or more separate views from adjacent third-tier cameras, regardless of where the zoom action is performed. Accordingly, an image captured by a second-tier camera may be zoomed until it is at or near the minimum horizontal FOV 718.

The image may be further zoomed and/or the image resolution provided at that level of zoom may be increased in the same or similar manner to that described above for zooming between the first and second tiers. For example, the current image feed may be switched at a point when the displayed image region captured by a second-tier camera corresponds to a region simultaneously captured by one or more of the third-tier cameras, thereby maintaining a smooth flow in the image feed prior to and following the transition between camera tiers. Moreover, images captured by two or more of the third-tier cameras, at a level of zoom corresponding to the minimum horizontal FOV 718 of the second-tier cameras, may be panned horizontally between the third-tier camera ranges without stitching together images captured by the third-tier cameras in the same or similar manner as that discussed above in relation to the second-tier cameras.

The fourth tier of camera system 700 may include multiple fourth-tier cameras, such as five fourth-tier cameras (e.g., fourth-tier cameras 410/510/610 shown in FIGS. 4-6) that each capture images within a respective fourth-tier camera range 710 having a maximum horizontal FOV 728 and a minimum horizontal FOV 730. The fourth-tier cameras may be any suitable types of camera device, such as cameras having rectilinear projection lenses with fixed physical focal lengths. Additionally, the maximum horizontal FOVs of adjacent fourth-tier cameras may overlap in overlapped horizontal FOVs 732.

In various embodiments, as shown, the overlapped horizontal FOVs 732 of adjacent fourth-tier cameras may be at least as large as the minimum horizontal FOV 724 of one or more of the third-tier cameras. Accordingly, the overlapped horizontal FOVs 732 may provide enough coverage for the desired image width such that images may be effectively captured by the fourth-tiers cameras without requiring. In one example, the overlapped horizontal FOVs 732 may each provide enough overlap in the fourth tier to maintain the overall FOV provided in the second tier at the desired width. As such, when a second-tier camera is digitally zoomed to capture an area corresponding to the minimum horizontal FOV 724, the minimum horizontal FOV 724 of the second-tier camera will be narrow enough to fit within a corresponding overlapped horizontal FOV 732 and the view may be lined up with a view captured by at least one of the fourth-tier cameras without requiring stitching together of two or more separate views from adjacent fourth-tier cameras, regardless of where the zoom action is performed. Accordingly, an image captured by a third-tier camera may be zoomed until it is at or near the minimum horizontal FOV 724.

The image may be further zoomed and/or the image resolution provided at that level of zoom may be increased in the same or similar manner to that described above for zooming between the first and second tiers and/or between the second and third tiers. For example, the current image feed may be switched at a point when the displayed image region captured by a third-tier camera corresponds to a region simultaneously captured by one or more of the fourth-tier cameras, thereby maintaining a smooth flow in the image feed prior to and following the transition between camera tiers. Moreover, images captured by two or more of the fourth-tier cameras, at a level of zoom corresponding to the minimum horizontal FOV 724 of the third-tier cameras, may be panned horizontally between the fourth-tier camera ranges without stitching together images captured by the fourth-tier cameras in the same or similar manner as that discussed above in relation to the second- and third-tier cameras.

Single or multiple sensor cameras may be used in a variety of devices, such as smart phones, interactive screen devices, web cameras, head-mounted displays, video conferencing systems, etc. In some examples, a large number of sensors may be required in a single device to achieve a desired level of image capture detail and/or FOV range. SOC devices may commonly be used, for example, in camera applications that only support a single image sensor. In such conventional SOC systems, it is typically not feasible to just switch between sensors as this may require an unsuitable interval of time (e.g., for electrical interface initialisation, sensor setup, white balance adjustment, etc.) and the image would likely tend to stall and/or be corrupted during a transition. In some conventional systems, a custom ASIC/FPGA may be utilized to enable a camera to directly connect to a larger number of sensors simultaneously. However, such a custom ASIC or FPGA would likely be inefficient in terms of high-speed interfaces and replication of logical functions.

FIGS. 8 and 9 respectively illustrate exemplary systems 800 and 900 that each include multiple sensors that are connected and interfaced with a computing device (i.e., an image controller) in a manner that may overcome certain constraints of conventional multi-sensor setups. In at least one example, a camera device may move around a scene (i.e., by capturing images from different portions of the scene) in accordance with user input and/or automatic repositioning criteria to provide a virtual pan and/or zoom experience to the user. As the camera device adjusts the captured image region, not all sensors may need to be active at the same time. Rather, only the current sensor and adjacent sensors that are likely to be utilized next may need to be operational and ready to go. Accordingly, in at least one embodiment, only a small number n of active sensors (e.g., 3-5 sensors) may be selected from the total number m of available sensors (e.g., 11 or more total sensors as shown in FIGS. 4-7), including the currently used sensor, the next left or right sensor and/or the next zoom in or out sensor.

Sensor selection may be based, for example, on the current image position of the virtual PTZ camera. By moving relatively slowly during panning, tilting, and/or zooming the image, the switching sensor latency (e.g., approximately 1-2 seconds) during switching between displayed cameras can be effectively hidden. According to one example, as shown in FIG. 8, m total sensors 804 that are available for image capture may each be connected to a physical layer switch 832 that connects only n selected sensors 804 to an integrated circuit, such as an SOC 834, at a particular time. Each of sensors 804 may be sensors of individual cameras (see, e.g., FIGS. 4-7) that include the sensors 804 and corresponding lenses. For example, as shown in FIG. 8, three sensors 804 out of m total sensors 804 may be actively utilized at any one time, via physical layer switching at physical layer switch 832, to transmit data to an image controller, such as SOC 834, via corresponding interfaces (I/Fs) 836. Corresponding image signal processing (ISP) modules 838 may be utilized to respectively process data received from each of the three actively utilized sensors. The data processed by the ISP modules 838 may then be received at a processor 840, which may include a central processing unit (CPU) and/or graphics processing unit (GPU) that modifies the received image data from at least one of sensors 804 to provide an image for viewing, such as a virtual panned, zoomed, and/or tilted image based on the image data received from the corresponding sensor 804. A camera interface (I/F) 842 may then receive and transmit the processed image data to one or more other devices for presentation to and viewing by a user via a suitable display device.

In some examples, as shown in FIG. 9, n selected sensors 904 (e.g., 3-5 sensors) of m total sensors 904 may be connected via a physical switch 932 and n internet service provider (ISP) devices 944 to corresponding universal serial bus interface (USB I/F) devices 946 and/or other suitable interface devices configured to interface with and transmit the image data to one or more external computing devices for further image processing and/or display to a user. Physical switching of the active image sensors at physical layer switch 832/932 and/or processing of image data from the active image sensors may be controlled automatically and/or via input from a user that is relayed to physical layer switch 832/932, SOC 834, and/or USB I/F devices 946. Accordingly, sensors 804/904 of corresponding cameras in system 800/900 may be activated and/or actively controlled and selected image data from the active sensors may be controlled and processed to provide a virtual PTZ camera view to one or more users.

FIGS. 10 and 11 illustrate an exemplary multi-sensor camera system that includes 4 tiers of sensors/cameras, allowing for up to 4 levels of zoom, with a total of 11 sensors distributed throughout the 4 tiers. As shown in this example, the first tier of cameras/sensors (i.e., corresponding to the leftmost sensor in FIG. 10) may include a single sensor 1004 that is operated with a wide-angle lens providing a wide-angle FOV. The focal lengths of the sensors and lenses in the additional second through fourth tiers may increase progressively as the corresponding FOVs decrease at each tier. In some examples, additional lenses may also be included in the cameras at each subsequent tier to enable a greater overall image capture region. For example, as shown in FIG. 10 and proceeding from left to right, the second tier may include two second-tier sensors 1006, the third tier may include three third-tier sensors 1008, and the fourth tier may include five fourth-tier sensors 1010. The first-, second-, third-, and fourth-tier sensors 1004-1010 may respectively have maximum horizontal FOVs 1104, 1106, 1108, and 1110 represented in FIG. 11.

As illustrated in FIG. 10, the sensors may each be selectively routed to one of a plurality of multiplexers, such as three multiplexers 1048A, 1048B, and 1048C. For example, labels A, B, and C respectively associated with multiplexers 1048A, 1048B, and 1048C in FIG. 10 may correspond to labels A, B, and C shown in FIG. 11 and associated with the illustrated maximum horizontal FOVs 1104-1110 of the respective cameras at each tier, with image data from the associated sensors 1004-1010 being selectively routed to the matching multiplexer 1048A-C in FIG. 10. For example, image data from each of the “A” camera sensors may be routed to multiplexer 1048A, image data from each of the “B” camera sensors may be routed to multiplexer 1048B, and image data from each of the “C” camera sensors may be routed to multiplexer 1048C. In some examples, at a particular time interval, each multiplexer 1048A, 1048B, and 1048C shown in FIG. 10 may select a single connected sensor that is activated and sends image data to that multiplexer. Additionally, a multiplexer control unit 1050 may be connected to each of multiplexers 1048A-C and may be utilized to select which one of multiplexers 1048A-C transmits data for display to a user. Accordingly, while all three of multiplexers 1048A-C may receive image data from a corresponding active camera sensor, the image data from only one of multiplexers 1048A-C may be transmitted at any given time. The image data from each of multiplexers 1048A-C may be transmitted, for example, from a corresponding output 1052.

The routing of the sensors may be selected and laid out to ensure that the active sensors queued up at a particular time have a highest potential as a next image target and to further ensure that any two potential image targets are connected to different multiplexers when possible. Accordingly, adjacent sensors along a potential zoom and/or pan path may be selectively routed to multiplexers 1048A-C so as to ensure that a multiplexer used to receive a currently displayed image is different than a next potential multiplexor used to receive a succeeding image. The sensors may be connected to the multiplexers in such a way that, when a currently display image is received and transmitted by one multiplexer, the other two selected multiplexers are configured to receive data from two sensors that are likely to be utilized next. For example, one or more adjacent cameras in the same tier and/or one or more cameras in one or more adjacent tiers covering an overlapping or nearby FOV may be received at the other multiplexers that are not currently being utilized to provide displayed images. Such a setup may facilitate the selection and activation (i.e., active queuing) of sensors that are likely to be utilized in succession, thus facilitating a smooth transition via switching between sensors during pan, zoom, and tilt movements within the imaged environment. Final selection of the current active sensor may be made downstream of the multiplexers inside an SOC (e.g., SOC 834 in FIG. 8) for example. For example, each of multiplexers 1048A, 1048B, and 1048C may receive image data from a corresponding activated sensor and send that image data to SOC 834 or another suitable device for further selection and/or processing.

In at least one example, when first-tier sensor 1004, which is an “A” sensor, is activated and used to generate a currently-displayed image that is sent to multiplexer 1048A, second-tier sensors 1006, which are “B” and “C” sensors routed to multiplexers 1048B and 1048C, may also be activated. Accordingly, when a current target image is zoomed, the image data may be smoothly switched from that received by multiplexer 1048A to image data received by multiplexer 1048B or 1048C from a corresponding one of second-tier sensors 1006. Since the sensors 1006 respectively connected to multiplexers 1048B and 1048C are already active and transmitting image data prior to such a transition, any noticeable lag between display of the resulting images may be reduced or eliminated. Similarly, when, for example, the central third-tier sensor 1008, which is an “A” sensor, is activated and used to generate a currently-displayed image that is sent to multiplexer 1048A, adjacent third-tier sensors 1008, which are “B” and “C” sensors routed to multiplexers 1048B and 1048C, may also be activated. Accordingly, when a current target image is panned, the image data may be smoothly switched from that received by, multiplexer 1048A to image data received by multiplexer 1048B or 1048C from a corresponding one of the adjacent third-tier sensors 1008. Since the adjacent third-tier sensors 1008 respectively connected to multiplexers 1048B and 1048C are already active and transmitting image data prior to such a transition from multiplexer 1048A, any noticeable lag between display of the resulting images may be reduced or eliminated.

FIGS. 12 and 13 illustrate exemplary total and minimum horizontal FOVs provided by sensors in each of four tiers of a virtual PTZ camera system. In many environments, PTZ pan and tilt ranges may become excessive at deeper focal distances into a room or space. Accordingly, in some examples, cameras at each successive tier may be able to narrow down their total FOV (e.g., total horizontal and/or vertical FOV provided by the combination of sensors in each tier), thereby reducing the number of lenses required and/or improving angular resolution of the received images. Such a narrowed field may be represented by boundary 1250 shown in FIG. 12.

In some embodiments, as shown in FIGS. 12 and 13, the first tier may have a total, or maximum, horizontal FOV 1252 of, for example, approximately 110-130 degrees (e.g., approximately 120 degrees. The wide-angle FOV may be provided by, for example, a wide-angle lens, such as a fisheye lens. Additionally, the second tier may have a total horizontal FOV 1254 of approximately 70-90 degrees (e.g., approximately 80 degrees), the third tier may have a total horizontal FOV 1256 of approximately 50-70 degrees (e.g., approximately 60 degrees), and the fourth tier may have a total horizontal FOV 1258 of approximately 30-50 degrees (e.g., approximately 40 degrees). The total horizontal FOV for each of the second through fourth tiers may represent a total viewable horizontal range provided by the combination of cameras at each of the tiers. In the pictured example illustrated in FIG. 13, each of the two sensors in the second tier may have maximum horizontal FOVs 1216 of approximately 55-65 degrees (e.g., approximately 61 degrees), each of the sensors in the third tier may have maximum horizontal FOVs 1222 of approximately 41 degrees approximately 35-40 degrees (e.g., approximately 41 degrees), and each of the sensors in the fourth tier may have maximum horizontal FOVs 1228 of approximately 25-35 degrees (e.g., approximately 28 degrees).

Having multiple tiers that are each optimized for part of the zoom range at each tier may allow fixed focus lenses to be effectively utilized and optimized. In some embodiments, the asymmetric aspect ratio and a 90-degree rotation of the image sensors (e.g., during a rotation of sensors and/or sensor array from landscape to portrait mode) for later tiers may also provide higher vertical FOV. Additionally, as shown in FIG. 13, the overlapping FOVs of the sensors and the high sensor pixel densities may facilitate displaying of high-definition (HD) images at various levels of zoom using image sensors with suitable pixel densities, such as a pixel density of from approximately 4k to approximately 7k horizontal pixels (e.g., approximately 5.5k horizontal pixels in each sensor at each tier). As shown, the first-tier sensor may provide a high-definition (HD) image with a minimum horizontal FOV 1214 of approximately 35-45 degrees (e.g., approximately 42 degrees), the second-tier sensors may each provide an HD image with a minimum horizontal FOV 1218 of approximately 15-25 degrees (e.g., approximately 22 degrees), the third-tier sensors may provide an HD image with a minimum horizontal FOV 1224 of approximately 10-20 degrees (e.g., approximately 15 degrees), and the fourth-tier sensors may provide an HD image with a minimum horizontal FOV 1230 of approximately 5-15 degrees (e.g., approximately 10 degrees). Moreover, the second-tier sensors may have an overlapped horizontal FOV 1220 of approximately 35-45 degrees or more, adjacent third-tier sensors may have an overlapped horizontal FOV 1226 of approximately 15-25 degrees or more, and adjacent fourth-tier sensors may have an overlapped horizontal FOV 1232 of approximately 10-20 degrees or more.

FIG. 14 shows an exemplary multi-sensor camera system 1400 in which a wide-angle sensor 1404 of a primary camera at a first tier is connected to its own separate interface (I/F) 1436A in an SOC 1434. As shown, sensors 1405 in cameras at additional tiers may be selectively coupled to the SOC 1434 via a physical layer switch 1432, as described above (see, e.g., FIG. 8). For example, sensors 1405 of cameras at second and higher tiers may be connected to a physical layer switch 1432, and image data from active cameras may be transmitted from physical layer switch 1432 to respective interfaces 1436B and 1436C. SOC 1434 may also include ISP modules 1438 corresponding to each of interfaces 1436A-C and a processor 1440, which may include a CPU and/or GPU that modifies the received image data from at least one of the active sensors to provide an image for viewing. In various embodiments, using a wide-angle lens, such as a fisheye lens, in the primary camera may provide a wider maximum FOV than other tiers and the connection to dedicated interface 1436A may allow sensor 1404 to be maintained in an active state to continuously or frequently sense objects and/or people within the sensor viewing area so as to actively assess and direct the framing and selection of other sensors in other tiers corresponding to higher degrees of zoom.

FIG. 15 illustrates an exemplary multi-sensor camera system 1500 having six tiers of sensors. In this example, horizontal FOVs provided by sensors in each of the six tiers are shown and system 1500 may utilize overlapping FOVs and relatively high sensor pixel densities to provide ultra-HD (UHD) images. In some examples, as shown, the first tier may have a total, or maximum, horizontal FOV 1512 of approximately 110-130 degrees (e.g., approximately 120 degrees) provided by, for example, a wide-angle lens, such as a fisheye lens. Additionally, the second tier may have a total horizontal FOV of approximately 100-120 degrees (e.g., approximately 110 degrees), with each of the two sensors in the second tier having maximum horizontal FOVs 1516 of approximately 90-100 degrees (e.g., approximately 94 degrees). In various examples, the cameras at the second tier may also include wide-angle lenses to provide larger maximum FOVs.

The third tier may have a total horizontal FOV of approximately 90-110 degrees (e.g., approximately 100 degrees), with each of the sensors in the third tier having maximum horizontal FOVs 1522 of approximately 65-75 degrees (e.g., approximately 71 degrees). The fourth tier may have a total horizontal FOV of approximately 70-90 degrees (e.g., approximately 80 degrees), with each of the sensors in the fourth tier having maximum horizontal FOVs 1528 of approximately 50-60 degrees (e.g., approximately 56 degrees). The fifth tier may have a total horizontal FOV of approximately of approximately 50-70 degrees (e.g., approximately 60 degrees), with each of the sensors in the fifth tier having maximum horizontal FOVs 1560 of approximately 42 degrees of approximately 35-45 degrees (e.g., approximately 42 degrees). The sixth tier may have a total horizontal FOV of approximately 30-50 degrees (e.g., approximately 40 degrees), with each of the sensors in the sixth tier having maximum horizontal FOVs 1566 of approximately 25-35 degrees (e.g., approximately 29 degrees). The sensors may be arranged such that the physical distance between a particular sensor and the sensors which may be used next (e.g., left, right and n−1 tier, n+1 tier) is minimized. This may, for example, reduce parallax effects and make switching between sensor images less jarring, particularly at UHD resolutions.

Additionally, as shown in FIG. 15, the sensors may have high pixel densities and the FOVs of adjacent sensors may overlap sufficiently to provide UHD images at various levels of zoom. In some examples, the overlapping FOVs of the sensors and the high sensor pixel densities may facilitate (UHD) images at various levels of zoom using image sensors with suitable pixel densities, such as a pixel density of from approximately 4k to approximately 8k horizontal pixels (e.g., approximately 6k horizontal pixels in each sensor at each tier). As shown, the first-tier sensor may provide a UHD image with a minimum horizontal FOV 1514 of approximately 70-85 degrees (e.g., approximately 77 degrees), the second-tier sensors may provide a UHD image with a minimum horizontal FOV 1518 of approximately 55-65 degrees (e.g., approximately 61 degrees), the third-tier sensors may provide a UHD image with a minimum horizontal FOV 1524 of approximately 40-50 degrees (e.g., approximately 46 degrees), the fourth-tier sensors may provide a UHD image with a minimum horizontal FOV 1530 of approximately 30-40 degrees (e.g., approximately 36 degrees), the fifth-tier sensors may provide a UHD image with a minimum horizontal FOV 1562 of approximately 20-30 degrees (e.g., approximately 27 degrees), and the sixth-tier sensors may provide a UHD image with a minimum horizontal FOV of approximately 15-25 degrees (e.g., approximately 19 degrees).

Moreover, the second-tier sensors may have an overlapped horizontal FOV 1520 of approximately 70-85 degrees or more, adjacent third-tier sensors may have an overlapped horizontal FOV 1526 of approximately 55-65 degrees or more, adjacent fourth-tier sensors may have an overlapped horizontal FOV 1532 of approximately 40-50 degrees or more, adjacent fifth-tier sensors may have an overlapped horizontal FOV 1564 of approximately 30-40 degrees or more, and adjacent sixth-tier sensors may have an overlapped horizontal FOV 1570 of approximately 20-30 degrees or more.

In certain embodiments, instead of utilizing a single sensor at a time, multiple sensors may be utilized to simultaneously capture multiple images. For example, two sensors may provide both a people view and a separate whiteboard view in a split or multi-screen view. In this example, one or both of the active cameras providing the displayed images may function with restrictions limiting how freely and/or seamlessly the sensors are able to move around and/or change views (e.g., by switching between sensors as described herein).

According to some embodiments, a virtual PTZ camera system may use multiple cameras with different fields of view in a scalable architecture that can achieve large levels of zoom without any moving parts. The multiple cameras may be controlled by software that chooses a subset of the cameras and uses image processing to render an image that could support a “virtual” digital pan-tilt-zoom camera type experience (along with other experiences in various examples). Benefits of such technology may include the ability to provide a zoomed view of any portion of a room while simultaneously maintaining awareness through a separate camera capturing a full view of the room. Additionally, the described systems may provide the ability to move a virtual camera view without user intervention and fade across multiple different cameras in a way that is seamless to the user and seems like a single camera. Additionally, users in a field of view of the system may be tracked with much lower latency than a conventional PTZ due to the use of all-digital imaging that does not rely on mechanical motors to move cameras or follow users. Moreover, the described systems may use lower cost camera modules, which, in combination, may achieve image quality competitive with a higher end digital PTZ camera that utilizes a more costly camera and components.

According to various embodiments, the described technology may be utilized in interactive smart devices and workplace communication applications. Additionally, the same technologies may be used for other applications such as AR/VR, security cameras, surveillance, or any other suitable application that can benefit from the use of multiple cameras. The described systems may be well-suited for implementation on mobile devices, leveraging technology developed primarily for the mobile device space.

FIG. 16 illustrates imaged regions of an environment 1600 captured by an exemplary virtual PTZ camera system, such as that shown in FIGS. 1A-2. As discussed above in relation to FIGS. 1A-2, virtual PTZ camera system 100 may have at least two tiers of sensors with partially overlapping horizontal FOVs of sensors. A primary camera 104 of virtual PTZ camera system 100 may include, for example, a wide-angle lens (e.g., a fisheye lens) and a sensor to capture image data from an environment. Virtual PTZ camera system 100 may also include a plurality of secondary cameras (i.e., second-tier cameras), such as secondary cameras 106A, 106B, and 106C, at locations near primary camera 104. In certain examples, one or more lenses may have optical axes that are tilted with respect to each other. For example, secondary cameras 106A and 106C may be angled inward slightly toward primary camera 104, with secondary camera 106B oriented parallel to primary camera 104 and not angled, as shown in FIG. 2. The secondary cameras 106A and 106C may be oriented inward to ensure, for example, that a desired framing of a subject, such as a human torso, fits fully within both the FOVs of neighbouring cameras as long as the subject is beyond a threshold distance away from the cameras. This condition provides, for example, that in a transition zone between FOVs, both secondary cameras 106A and 106C may have sufficient available data to fuse a synthesized view as described herein.

Returning to FIG. 16, a virtual PTZ camera system 1602 (see, e.g., system 100 in FIGS. 1A-2) may be positioned to capture images from environment 1600 that includes one or more subjects of interest, such as an individual 1604 as shown. A wide-angle camera (e.g., primary camera 104) of camera system 1602 may have a wide-angle FOV 1606, and secondary cameras (e.g., secondary cameras 106A, 106B, and 106C in FIGS. 1A-2) of camera system 1602 may have respective horizontal FOVs 1608A, 1608B, and 1608C that partially overlap each other and overlap wide-angle FOV 1606.

In the example shown, two neighboring secondary cameras may have overlapping FOVs 1608B and 1608C such that a 16:9 video framing a crop of the torso of individual 1604 at a distance of, for example, approximately 2 meters would be guaranteed to fall within FOVs 1608B and 1608C. Such a framing would allow either for displayed images to be transitioned between the cameras with a sharp cut, cross-fade, or any other suitable view interpolation method as described herein. If the cameras have sufficient redundant overlap, then the camera input to an application processor may be switched between the center and right cameras having FOVs 1608B and 1608C during a frame transition, with little or no delay as described above. Accordingly, such a system may be capable of operating with only two camera inputs, including one input for a wide-angle view and the other input for either a right or center view, depending on the user's current position.

Inputs to the system may be an array of individual cameras streaming video images, which may be synchronized in real-time to an application processor that uses the constituent views to synthesize an output video. The final video feed may be considered a video image (i.e., a virtual camera view) that is synthesized from one or more of the multiple cameras. The control of the virtual camera view placement and camera parameters may be managed by the manual intervention of a local or remote user (e.g., from a console), or under the direction of an automated algorithm, such as an artificial intelligence (AI)-directed Smart Camera, that determines a desired virtual camera to render given contextual information and data gathered about the scene. The contextual information from the scene can be aggregated from the multiple cameras and other sensing devices of different modalities (e.g., computer-vision cameras or microphone arrays) that can provide additional inputs to the application processor.

One or more individuals (or other relevant objects of salient interest, like pets, a birthday cake, etc.), which may influence the placement of a final video feed may be detected from some subset of the available cameras in order to build understanding of the scene and its relevant objects. This detection may be an AI-detection deep learning method such as that used in pose estimation fora smart camera device. The results of the detection operation may be used by an automatic algorithm to determine the final desired camera view parameters and which of the physical cameras should be activated or prioritized in the processing to achieve the desired virtual camera view.

In one configuration, as illustrated in FIG. 17, an AI detection method may detect objects or persons of interest, such as individual 1704, in a camera view 1700 (e.g., wide-angle FOV 1606 in FIG. 16) that has widest visibility of the entire space. In this way, only one camera may be tasked with detecting the state of the scene in camera view 1700 and other cameras in the virtual PTZ camera system may simply provide video image data that may be used for synthesis of a final virtual camera view. For example, upon detection of the individual 1704, a camera having FOV 1702 may be used to capture image data that is utilized to generate the displayed virtual camera images. In some cases, a subset of cameras that aren't needed to generate the desired virtual camera view may be turned off or put into a low power sleep state. A predictive or automated algorithm may be used to anticipate the required power state of individual cameras based on activities occurring within the scene and turn them on or off as required.

In some embodiments, there may be no single camera that has a view of everything, so an AI detection task may be distributed or rotated over multiple cameras in a temporal manner. For example, AI detection may run once on a frame from one camera, next on a frame from another camera, and so on (e.g., in round robin fashion) in order to build a larger model of the scene than may be achieved from a single camera. It may also use detection in multiple cameras to get a more accurate detection distance of the object through triangulation from a stereo or other multiple camera method. In one case, the AI detection task may be rotated periodically amongst zoomed and wide views in order to detect relevant objects that may be too distant (i.e., at too low a resolution) to result in successful detection in wider FOV cameras.

In another embodiment, one or more of the physical cameras may have their own dedicated built-in real-time AI-enabled co-processing or detection hardware and may stream detection results without necessarily providing an image. A processing unit may gather the metadata and object detection information from the distributed cameras and use them to aggregate its model of the scene, or to control and down-select which cameras provide image data to a more powerful AI detection algorithm. The AI detection software may use detection metadata from the different cameras to determine how to temporally share limited AI resources across multiple cameras (e.g., making the ‘round-robin’ rotation of cameras through the AI detection dependent on individual detections from the particular cameras). In another method, environment detection data from the individual cameras may be used to set a reduced region of interest to save bandwidth and power or conserve processing resources when streaming images to an application processor.

Accordingly, the widest FOV camera in the virtual PTZ camera system may be used for AI understanding of the scene because it has the ability to broadly image objects in the environment, and also for a mobile device there are typically not enough AI resources to process all the camera feeds. However, in some cases, for multiple cameras, the AI and detection tasks may need to be rotated across different cameras or the processing may also be partially or wholly distributed to various individual cameras.

FIG. 18 illustrates an exemplary environment 1800, such as a conference room, that may be captured by a multicamera virtual PTZ camera system 1801 having 10 cameras arranged in tiers (see, e.g., FIGS. 4-15). For example, camera system 1801 may include a wide-angle camera at a first tier that captures a maximum horizontal FOV 1802. Additionally, camera system 1801 may include, for example, three second-tier cameras that capture three overlapping maximum horizontal FOVs 1804, three third-tier cameras that capture three overlapping maximum horizontal FOVs 1806, and three fourth-tier cameras that capture three overlapping maximum horizontal FOVs 1808. The views from each of the tiers of cameras may provide various degrees of zoom and resolution covering the environment, which in this example includes a conference table 1812 and multiple individuals 1810.

Many hardware devices that may implement an AI-detection algorithm may only support a limited number of camera inputs. In some cases, as shown in FIG. 18, the number of cameras (10) may exceed the number of available inputs for image processing in an application processor (often only 2 or 3 inputs are available as described above). Additionally, processing of an Image Signal Processor (ISP) block on an application processor may have limited bandwidth and may only be able to process a certain number of images within a frame time. Therefore, an algorithmic approach may reduce the number of video inputs using information about the scene in order to select which of the multiple cameras are most relevant to tasks of (1) synthesizing a required virtual camera view and (2) maintaining its model of what is happening in the scene.

In one embodiment, with virtual PTZ camera system 1801 having more cameras than inputs, access to the camera port on a mobile application processor may be mediated by another separate hardware device (e.g., a multiplexer, MUX, as shown in FIGS. 8-10 and 14) that may host additional cameras and control access to a limited number of ports on the mobile application processor. The MUX device may also have special purpose hardware or software running on it that is dedicated to controlling initialization and mode switching of the multiple connected cameras. In some cases, the MUX device may also use on-board AI processing resources to shorten the time needed to power up or power down the individual cameras in order to save power. In other cases, the MUX device may aggregate AI data streamed from connected AI-enabled cameras in order to make decisions related to waking up or sleeping the sensors independently of the mobile application processor. In another embodiment, the MUX device may apply specialized image processing (e.g., AI denoising in the raw domain) to one or more of the streams input to the mobile application processor to improve apparent image quality or improve detection accuracy. In another embodiment, the MUX device may combine or aggregate portions of image data from multiple camera streams into fewer camera streams in order to allow partial data from more cameras to access the mobile application processor. In another approach, the MUX device may implement a simple ISP and downscale the images from a subset of the multiple cameras to reduce the bandwidth required for AI detection on the application processor. In an additional approach, the MUX device may itself implement the AI detection directly on selected camera streams and provide the information to the application processor.

A technique, such as an algorithmic technique, for selecting limited inputs from a plurality of inputs may be carried out as follows. Pose and detection information of one or more subjects, such as individuals 1810 in a scene of environment 1800, may be identified through AI detection in the widest frame and may include information concerning the position and relevant key points or bounding boxes of one or more of individuals 1810 (e.g., identification of shoulders, head, etc. as depicted in FIG. 17). Once the pose and detection information are known for individuals 1810 in the scene, an automatic algorithm may, for example, determine, based on the pose and detection information, a desired ‘virtual’ output camera view to be generated for the final displayed video (e.g., a smart camera view).

A “virtual” camera may be thought of as a specification of an effective camera (e.g., derived from intrinsics, extrinsics, and/or a projection model) for which an image may be generated by the system from the multiple cameras. In practice, a virtual camera may have a projection model for the generated image (such as a Mercator projection model) that is not physically realizable in a real-camera lens. An automatic algorithm (e.g., a smart camera) may determine parameters of the virtual camera that will be rendered based on scene content and AI detections. In many cases, the position, projection, and rotation of the virtual camera may simply match the parameters of one of the physical cameras in the system. In other cases, or for selected periods of time, the parameters of the virtual camera, such as position, rotation, and zoom setting, may be some value not physically matched to any real camera in the system. In such cases, the desired virtual camera view may be synthesized through software processing using image data from a subset of the available multiple cameras (i.e., some sort of view interpolation).

Once the pose and detection information of the person(s) or object(s) of interest in the scene is known relative to the wide-angle camera corresponding to maximum horizontal FOV 1802 shown in FIG. 18, the desired virtual view may be composed using an additional subset of cameras in the second-, third-, and/or fourth-tiers (corresponding to maximum FOVs 1804, 1806, and/or 1808 shown in FIG. 18). First, because the cameras may all be calibrated and the relative positions of all may be known (e.g., based on determined intrinsic and extrinsic data), a subset of the real cameras which have full or partial field-of-view overlap with the desired virtual view may be calculated. These may be kept as candidates for selection as they contain at least some portion of image data that may contribute to the synthesis of the ultimate virtual camera view.

If a further reduced subset of cameras is required due to limited inputs or limitations of the processing platform, then, for example, the algorithm may choose a subset of cameras of virtual PTZ camera system 1801 using additional criteria, such as best stitching and/or best quality criteria. Best stitching criteria may be used to calculate a set of cameras of highest zoom that may synthesize the desired virtual camera view in the union of their coverage when blended or stitched together. Best quality criteria may be used to determine a camera having the best quality (e.g., the most ‘zoomed’ camera) that still fully (or mostly) overlaps the required virtual camera view.

FIG. 19 shows exemplary views of selected cameras from a virtual PTZ camera system, such as camera system 1602 shown in FIG. 16. As shown in FIG. 19, two narrower-view cameras, such as second-tier cameras, may split a view of an environment into a first FOV 1902 and a second FOV 1904, which are also covered by a much larger wide-angle FOV 1906 from a first-tier camera. The virtual camera view desired by the smart camera technique may center the individual 1908 within the resulting virtual image. In this way, the virtual camera view may be synthesized from any (or all) of the three views in the camera array. Note that the images from all the cameras may be reprojected to a non-physically realizable virtual camera projection space (e.g., a Mercator projection), which is, in essence, a virtual camera that has a lens that creates a Mercator wide-angle projection. Although a Mercator projection may be utilized in some examples, any other suitable projection may additionally or alternatively be used for the virtual camera.

FIG. 20 shows exemplary views of selected cameras from a virtual PTZ camera system, such as camera system 1602 shown in FIG. 16. As shown in FIG. 20, two narrower-view cameras, such as second-tier cameras, may split a view of an environment into a first FOV 2002 and a second FOV 2004, which are also covered by a much larger wide-angle FOV 2006 from a first-tier camera. In this case, the desired virtual camera may be moved to a location in the scene where it is only partially overlapped by some of the camera views of the camera system. For example, while individual 2008 is fully visible in wide-angle FOV 2006, only portions of individual 2008 may be visible in each of the narrower first and second FOVs 2002 and 2004. Accordingly, only the wide-camera view may fully contain the content needed to synthesize the desired virtual camera view. The synthesized virtual camera's position may temporarily or constantly not coincide with any particular camera in the array, particularly during transition periods between cameras. In one embodiment, the virtual camera may change its primary view position to coincide with a particular camera in the camera system array that most closely overlaps with the position of the desired virtual camera. In another embodiment the virtual camera may switch positions in a discrete manner to make a quick cut between cameras in the output video view.

In cases when the virtual camera view is in a position not coinciding with the physical cameras, a view may be synthesized from a subset of camera views (e.g., from two or more cameras) neighboring the position of the desired virtual camera. The virtual view may be generated by any suitable technique. For example, the virtual view may be generated using homography based on motion vectors or feature correspondences between two or more cameras. In at least one example, the virtual view may be generated using adaptive image fusion of two or more cameras. Additionally or alternatively, the virtual view may be generated using any other suitable view interpolation method, including, without limitation, (1) depth-from-stereo view interpolation, (2) sparse or dense motion vectors between two or more cameras, (3) synthetic aperture blending (image-based techniques), and/or (4) Deep-learning based view interpolation

In the methods for view interpolation, as described above, depth or sparse distance information may be necessary and/or may improve the quality of the image operations. In one embodiment, a multi-view stereo depth detection or feature correspondence may be performed on the multiple camera streams to generate a depth map or multiple depth maps of the world space covered by the multiple cameras. In some examples, one or more depth maps may be calculated at a lower frame rate or resolution. In additional examples, a 3D or volumetric model of the scene may be constructed over multiple frames and refined over time to improve the depth needed to generate clean view interpolations. In at least one example, AI processing of single or multiple RGB images may be used to estimate the depth of key objects or persons of interest in the scene. Additionally or alternatively, multi-modal signals from a system, such as a microphone array, may be used to estimate the depth to one or more subjects in a scene. In another example, depth information may be provided by actively illuminated sensors for depth such as structured light, time-of-flight (TOF), and/or light detection and ranging (Lidar).

The simplest realization of the above framework is a dual camera system that includes one wide-angle camera with a full view of the scene and one narrower-angle camera with better zoom. If two cameras are utilized in the system, the wide-angle camera may be set up to take over when a user is outside the maximum FOV of the narrow camera. If a user is inside the FOV of the narrower camera, then the narrower camera may be used to generate the output video because it has the higher image quality and resolution of the two cameras. There are two main options that may be considered for the final virtual camera view in this scenario. In the first option, the virtual camera may always rest on the position of the wider of the two cameras, and the narrower camera information may be constantly fused into that of the wider camera through depth projection. In the second option, the virtual camera may transition from the position of one camera to the other camera. For the time in between, a view may be interpolated during a video transition. Once the transition is over the new camera may become the primary view position. An advantage of the second option may be that there is a resultant higher image quality and less artifacts because the period of view interpolation is only limited to transitions between the cameras. This may reduce the chance that a user will perceive the differences or artifacts bbetween the two cameras during the transition period between cameras.

Because of the potential risks and expensive processing often needed for view interpolation, in order to realize this technique on a real device, the following additional strategies may make view interpolation more practical. In one example, video effects, such as cross-fade, may be used to transition all the way from one camera to the other. This may avoid costly processing associated with view interpolation because it only relies on simpler operations such as alpha blending. According to some examples, the transitions may be triggered to coincide with other camera movements such as zooming in order to hide the noticeability of switching the cameras. In additional examples, the camera may be controlled to transition only when it is least likely to be noticeable.

In some embodiments, the following potentially less-expensive strategies may be utilized instead of or in addition to view interpolation. In one example, a quick cut may simply be performed between the two cameras, with no transition or a limited transition period. A simple cross fade may be performed between the two cameras while applying a homography on one of the two images to prioritize keeping the face and body aligned between the two frames. In another example, a cross fade may be performed while mesh-warping keypoints from the start to the end image. According to at least one example, a more expensive view interpolation may be performed for the transition (as noted above). Additionally, in some cases, to create the virtual output image, multiple cameras may be stitched or fused together constantly in a way that might spatially vary across the frame. For example, a method may be used to fuse key content in higher resolution. For example, only the face would come from one camera and the rest of the content would come from another camera.

Multi-sensor camera devices, systems, and methods, as disclosed herein, may provide virtual pan, tilt, and zoom functionality without the need for moving parts, thereby reducing the space requirements and overall complexity in comparison to conventional PTZ camera systems. In some embodiments, the approach may use a large number of smaller image sensors with overlapping horizontal fields of view arranged in tiers, with the sensors and lenses being more cost-effective than larger sensors and/or lens configurations, particularly in cases where, for example, up to four or more separate sensors may be included in a single SOC component. A mixture of digital and fixed optical zoom positions may provide substantial coverage of an environmental space at various levels of zoom and detail. Multiplexing/switching at the electrical interface may be used to connect the large number of sensors to SOCs or USB interface devices.

FIGS. 21 and 22 are flow diagrams of exemplary methods 2100 and 2200 for operating a virtual PTZ camera system in accordance with embodiments of this disclosure. As illustrated in FIG. 21, at step 2110, image data may be received from a primary camera. At step 2120 in FIG. 21, image data may be received from a plurality of secondary cameras that each have a maximum horizontal FOV that is less than a maximum horizontal FOV of the primary camera. In this example, two of the plurality of secondary cameras may be positioned such that their maximum horizontal FOVs overlap in an overlapped horizontal FOV. Additionally, the overlapped horizontal FOV may be at least as large as a minimum horizontal FOV of the primary camera.

The systems and apparatuses described herein may perform steps 2110 and 2120 in a variety of ways. In one example, image data may be received by a physical layer switch 832 from sensors 804 of a primary camera and a plurality of secondary cameras (see, e.g., FIGS. 4-8). Each of the secondary cameras (e.g., second-tier cameras) may have a maximum horizontal FOV 716 that is less than a maximum horizontal FOV 712 of the primary camera (first-tier camera) (see, e.g., FIG. 7). Additionally, for example, two of the plurality of secondary cameras may be positioned such that their maximum horizontal FOVs 716 overlap in an overlapped horizontal FOV 720. Additionally, the overlapped horizontal FOV 720 may be at least as large as a minimum horizontal FOV 714 of the primary camera.

At step 2130 in FIG. 21, two or more of the primary camera and the plurality of secondary cameras may be simultaneously activated when capturing images from a portion of an environment included within the overlapped horizontal FOV. The systems and apparatuses described herein may perform step 2130 in a variety of ways. In one example, an image controller, such as SOC 834 and/or physical layer switch (832), may activate the two or more cameras. An image controller, as described herein, may include at least one physical processor and at least one memory device,

FIG. 22 shows another exemplary method for operating a virtual PTZ camera system in accordance with embodiments of this disclosure. As, at step 2210, image data may be received from a primary camera. At step 2220 in FIG. 22, image data may be received from a plurality of secondary cameras that each have a maximum horizontal FOV that is less than a maximum horizontal FOV of the primary camera. In this example, two of the plurality of secondary cameras may be positioned such that their maximum horizontal FOVs overlap in an overlapped horizontal FOV. The systems and apparatuses described herein may perform steps 2210 and 2220 in a variety of ways.

At step 2230 in FIG. 22, two or more of the primary camera and the plurality of secondary cameras may be simultaneously activated when capturing images from a portion of an environment to produce a virtual camera image formed by a combination of image elements captured by the two or more of the primary camera and the plurality of secondary cameras. The systems and apparatuses described herein may perform step 2230 in a variety of ways. In one example, an image controller may simultaneously activate two or more of a primary camera and a plurality of secondary cameras (see, e.g., virtual PTZ camera systems 1602 and 1801 in FIGS. 16 and 18) when capturing images from a portion of an environment to produce a virtual camera image formed by a combination of image elements (see, e.g., FIGS. 19 and 20) captured by the two or more of the primary camera and the plurality of secondary cameras.

FIGS. 23-26 illustrate certain examples of devices and systems that may utilize multi-sensor camera devices as disclosed herein. The multi-sensor camera devices may additionally or alternatively be utilized in any other suitable devices and systems, including, for example, stand-alone cameras, smart phones, tablets, laptop computers, security cameras, and the like. FIG. 23 illustrates an exemplary interactive display system and FIG. 24 illustrates an exemplary camera device in accordance with various embodiments. Embodiments of the present disclosure may include or be implemented in conjunction with various types of image systems, including interactive video systems, such as those shown in FIGS. 23 and 24.

As shown, for example, in FIG. 23, a display system 2300 may include a display device that is configured to provide a user with an interactive visual and/or audio experience. The display device may include various features to facilitate communication with other users via an online environment. In some examples, the display device may also enable users to access various applications and/or online content. The display device may include any suitable hardware components, including at least one physical processor and at least one memory device, and software tools to facilitate such interactions. In various embodiments, the display device may include a camera assembly 2302, such as a multi-sensor camera system as described herein, that faces towards a user of the device. In some examples, the display device may also include a display panel that displays content obtained from a remote camera assembly on another user's device. In some embodiments, camera assembly 2302 may capture data from a region in front of the display panel.

In at least one embodiment, a camera device 2400 of FIG. 24 may include a camera assembly 2402 that faces toward an external region, such as a room or other location. In some examples, camera device 2400 may be coupled to a display (e.g., a television or monitor) to capture images of viewers and objects located in front of the display screen. Additionally or alternatively, camera assembly 2400 may rest on a flat surface, such as a table or shelf surface, with camera assembly 2402 facing toward an external user environment.

### EXAMPLE 1

A camera system may include a primary camera and a plurality of secondary cameras that each have a maximum horizontal FOV that is less than a maximum horizontal FOV of the primary camera. Two of the plurality of secondary cameras may be positioned such that their maximum horizontal FOVs overlap in an overlapped horizontal FOV and the overlapped horizontal FOV may be at least as large as a minimum horizontal FOV of the primary camera. The camera system may also include an image controller that simultaneously activates two or more of the primary camera and the plurality of secondary cameras when capturing images from a portion of an environment included within the overlapped horizontal FOV.

### EXAMPLE 2

The camera system of example 1, wherein at least one of the primary camera and the plurality of secondary cameras may include a fixed lens camera.

### EXAMPLE 3

The camera system of example 1, wherein the primary camera may include a fisheye lens.

### EXAMPLE 4

The camera system of example 1, wherein the secondary cameras may each have a greater focal length than the primary camera.

### EXAMPLE 5

The camera system of example 1, wherein the image controller may be configured to digitally zoom at least one of the primary camera and the plurality of secondary cameras by 1) receiving image data from the at least one of the primary camera and the plurality of secondary cameras and 2) producing images that correspond to a selected portion of the corresponding maximum horizontal FOV of the at least one of the primary camera and the plurality of secondary cameras.

### EXAMPLE 6

The camera system of example 5, wherein, when the image controller digitally zooms the primary camera to a maximum extent, the corresponding image produced by the image controller may cover a portion of the environment that does not extend outside the minimum horizontal FOV.

### EXAMPLE 7

The camera system of example 5, wherein the image controller may be configured to digitally zoom the at least one of the primary camera and the plurality of secondary cameras to a maximum zoom level corresponding to a minimum threshold image resolution.

### EXAMPLE 8

The camera system of example 5, wherein the image controller may be configured to digitally zoom between the primary camera and at least one secondary camera of the plurality of secondary cameras by 1) receiving image data from both the primary camera and the at least one secondary camera simultaneously, 2) producing primary images based on the image data received from the primary camera when a zoom level specified by the image controller corresponds to an imaged horizonal FOV that is greater than the overlapped horizontal FOV, and 3) producing secondary images based on the image data received from the at least one secondary camera when the zoom level specified by the image controller corresponds to an imaged horizonal FOV that is not greater than the overlapped horizontal FOV.

### EXAMPLE 9

The camera system of example 5, wherein the image controller may be configured to digitally pan horizontally between the plurality of secondary cameras when the images produced by the image controller correspond to an imaged horizonal FOV that is less than the overlapped horizontal FOV.

### EXAMPLE 10

The camera system of example 9, wherein the image controller may pan horizontally between an initial camera and a succeeding camera of the two secondary cameras by 1) receiving image data from both the initial camera and the succeeding camera simultaneously, 2) producing initial images based on the image data received from the initial camera when at least a portion of the imaged horizonal FOV is outside the overlapped horizontal FOV and within the maximum horizontal FOV of the initial camera, and 3) producing succeeding images based on the image data received from the succeeding camera when the imaged horizontal FOV is within the overlapped horizontal FOV.

### EXAMPLE 11

The camera system of example 1, further including a plurality of camera interfaces, wherein each of the primary camera and the two secondary cameras may send image data to a separate one of the plurality of camera interfaces.

### EXAMPLE 12

The camera system of example 11, wherein the image controller may selectively produce images corresponding to one of the plurality of camera interfaces.

### EXAMPLE 13

The camera system of example 11, wherein 1) each of the plurality of camera interfaces may be communicatively coupled to multiple additional cameras and 2) the image controller may selectively activate a single camera connected to each of the plurality of camera interfaces and deactivate the remaining cameras at a given time.

### EXAMPLE 14

The camera system of example 1, further including a plurality of tertiary cameras that each have a maximum horizontal FOV that is less than the maximum horizontal FOV of the of each of the secondary cameras, wherein two of the plurality of tertiary cameras are positioned such that their maximum horizontal FOVs overlap in an overlapped horizontal FOV.

### EXAMPLE 15

The camera system of example 14, wherein 1) the primary, secondary, and tertiary cameras may be respectively included within primary, secondary, and tertiary tiers of cameras and 2) the camera system may further include one or more additional tiers of cameras that each include multiple cameras.

### EXAMPLE 16

The camera system of example 1, wherein an optical axis of the primary camera may be oriented at a different angle than an optical axis of at least one of the secondary cameras.

### EXAMPLE 17

The camera system of example 1, wherein the primary camera and the plurality of secondary cameras may be oriented such that the horizontal FOV extends in a non-horizontal direction.

### EXAMPLE 18

A camera system may include a primary camera and a plurality of secondary cameras that each have a maximum horizontal FOV that is less than a maximum horizontal FOV of the primary camera, wherein two of the plurality of secondary cameras may be positioned such that their maximum horizontal FOVs overlap. The camera system may also include an image controller that simultaneously activates two or more of the primary camera and the plurality of secondary cameras when capturing images from a portion of an environment to produce a virtual camera image formed by a combination of image elements captured by the two or more of the primary camera and the plurality of secondary cameras.

### EXAMPLE 19

The camera system of example 18, wherein the image controller may further 1) detect at least one object of interest in the environment based on image data received from the primary camera, 2) determine a virtual camera view based on the detection of the at least one object of interest, and generate the virtual camera image corresponding to the virtual camera view using image data received from at least one of the activated plurality of secondary cameras.

### EXAMPLE 20

A method may include 1) receiving image data from a primary camera and 2) receiving image data from a plurality of secondary cameras that each have a maximum horizontal FOV that is less than a maximum horizontal FOV of the primary camera. Two of the plurality of secondary cameras may be positioned such that their maximum horizontal FOVs overlap in an overlapped horizontal FOV and the overlapped horizontal FOV may be at least as large as a minimum horizontal FOV of the primary camera. The method may further include simultaneously activating, by an image controller, two or more of the primary camera and the plurality of secondary cameras when capturing images from a portion of an environment included within the overlapped horizontal FOV.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 2500 in FIG. 25) or that visually immerses a user in an artificial reality (such as, e.g., virtual-reality system 2600 in FIG. 26). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 25, augmented-reality system 2500 may include an eyewear device 2502 with a frame 2510 configured to hold a left display device 2515(A) and a right display device 2515(B) in front of a user's eyes. Display devices 2515(A) and 2515(B) may act together or independently to present an image or series of images to a user. While augmented-reality system 2500 includes two displays, embodiments of this disclosure may be implemented in augmented-reality systems with a single NED or more than two NEDs.

In some embodiments, augmented-reality system 2500 may include one or more sensors, such as sensor 2540. Sensor 2540 may generate measurement signals in response to motion of augmented-reality system 2500 and may be located on substantially any portion of frame 2510. Sensor 2540 may represent one or more of a variety of different sensing mechanisms, such as a position sensor, an inertial measurement unit (IMU), a depth camera assembly, a structured light emitter and/or detector, or any combination thereof. In some embodiments, augmented-reality system 2500 may or may not include sensor 2540 or may include more than one sensor. In embodiments in which sensor 2540 includes an IMU, the IMU may generate calibration data based on measurement signals from sensor 2540. Examples of sensor 2540 may include, without limitation, accelerometers, gyroscopes, magnetometers, other suitable types of sensors that detect motion, sensors used for error correction of the IMU, or some combination thereof.

In some examples, augmented-reality system 2500 may also include a microphone array with a plurality of acoustic transducers 2520(A)-2520(J), referred to collectively as acoustic transducers 2520. Acoustic transducers 2520 may represent transducers that detect air pressure variations induced by sound waves. Each acoustic transducer 2520 may be configured to detect sound and convert the detected sound into an electronic format (e.g., an analog or digital format). The microphone array in FIG. 25 may include, for example, ten acoustic transducers: 2520(A) and 2520(B), which may be designed to be placed inside a corresponding ear of the user, acoustic transducers 2520(C), 2520(D), 2520(E), 2520(F), 2520(G), and 2520(H), which may be positioned at various locations on frame 2510, and/or acoustic transducers 2520(I) and 2520(J), which may be positioned on a corresponding neckband 2505.

In some embodiments, one or more of acoustic transducers 2520(A)-(J) may be used as output transducers (e.g., speakers). For example, acoustic transducers 2520(A) and/or 2520(B) may be earbuds or any other suitable type of headphone or speaker.

The configuration of acoustic transducers 2520 of the microphone array may vary. While augmented-reality system 2500 is shown in FIG. 25 as having ten acoustic transducers 2520, the number of acoustic transducers 2520 may be greater or less than ten. In some embodiments, using higher numbers of acoustic transducers 2520 may increase the amount of audio information collected and/or the sensitivity and accuracy of the audio information. In contrast, using a lower number of acoustic transducers 2520 may decrease the computing power required by an associated controller 2550 to process the collected audio information. In addition, the position of each acoustic transducer 2520 of the microphone array may vary. For example, the position of an acoustic transducer 2520 may include a defined position on the user, a defined coordinate on frame 2510, an orientation associated with each acoustic transducer 2520, or some combination thereof.

Acoustic transducers 2520(A) and 2520(B) may be positioned on different parts of the user's ear, such as behind the pinna, behind the tragus, and/or within the auricle or fossa. Or, there may be additional acoustic transducers 2520 on or surrounding the ear in addition to acoustic transducers 2520 inside the ear canal. Having an acoustic transducer 2520 positioned next to an ear canal of a user may enable the microphone array to collect information on how sounds arrive at the ear canal. By positioning at least two of acoustic transducers 2520 on either side of a user's head (e.g., as binaural microphones), augmented-reality device 2500 may simulate binaural hearing and capture a 3D stereo sound field around about a user's head. In some embodiments, acoustic transducers 2520(A) and 2520(B) may be connected to augmented-reality system 2500 via a wired connection 2530, and in other embodiments acoustic transducers 2520(A) and 2520(B) may be connected to augmented-reality system 2500 via a wireless connection (e.g., a BLUETOOTH connection). In still other embodiments, acoustic transducers 2520(A) and 2520(B) may not be used at all in conjunction with augmented-reality system 2500.

Acoustic transducers 2520 on frame 2510 may be positioned in a variety of different ways, including along the length of the temples, across the bridge, above or below display devices 2515(A) and 2515(B), or some combination thereof. Acoustic transducers 2520 may also be oriented such that the microphone array is able to detect sounds in a wide range of directions surrounding the user wearing the augmented-reality system 2500. In some embodiments, an optimization process may be performed during manufacturing of augmented-reality system 2500 to determine relative positioning of each acoustic transducer 2520 in the microphone array.

In some examples, augmented-reality system 2500 may include or be connected to an external device (e.g., a paired device), such as neckband 2505. Neckband 2505 generally represents any type or form of paired device. Thus, the following discussion of neckband 2505 may also apply to various other paired devices, such as charging cases, smart watches, smart phones, wrist bands, other wearable devices, hand-held controllers, tablet computers, laptop computers, other external compute devices, etc.

As shown, neckband 2505 may be coupled to eyewear device 2502 via one or more connectors. The connectors may be wired or wireless and may include electrical and/or non-electrical (e.g., structural) components. In some cases, eyewear device 2502 and neckband 2505 may operate independently without any wired or wireless connection between them. While FIG. 25 illustrates the components of eyewear device 2502 and neckband 2505 in example locations on eyewear device 2502 and neckband 2505, the components may be located elsewhere and/or distributed differently on eyewear device 2502 and/or neckband 2505. In some embodiments, the components of eyewear device 2502 and neckband 2505 may be located on one or more additional peripheral devices paired with eyewear device 2502, neckband 2505, or some combination thereof.

Pairing external devices, such as neckband 2505, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 2500 may be provided by a paired device or shared between a paired device and an eyewear device, thus reducing the weight, heat profile, and form factor of the eyewear device overall while still retaining desired functionality. For example, neckband 2505 may allow components that would otherwise be included on an eyewear device to be included in neckband 2505 since users may tolerate a heavier weight load on their shoulders than they would tolerate on their heads. Neckband 2505 may also have a larger surface area over which to diffuse and disperse heat to the ambient environment. Thus, neckband 2505 may allow for greater battery and computation capacity than might otherwise have been possible on a stand-alone eyewear device. Since weight carried in neckband 2505 may be less invasive to a user than weight carried in eyewear device 2502, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 2505 may be communicatively coupled with eyewear device 2502 and/or to other devices. These other devices may provide certain functions (e.g., tracking, localizing, depth mapping, processing, storage, etc.) to augmented-reality system 2500. In the embodiment of FIG. 25, neckband 2505 may include two acoustic transducers (e.g., 2520(I) and 2520(J)) that are part of the microphone array (or potentially form their own microphone subarray). Neckband 2505 may also include a controller 2525 and a power source 2535.

Acoustic transducers 2520(I) and 2520(J) of neckband 2505 may be configured to detect sound and convert the detected sound into an electronic format (analog or digital). In the embodiment of FIG. 25, acoustic transducers 2520(I) and 2520(J) may be positioned on neckband 2505, thereby increasing the distance between the neckband acoustic transducers 2520(I) and 2520(J) and other acoustic transducers 2520 positioned on eyewear device 2502. In some cases, increasing the distance between acoustic transducers 2520 of the microphone array may improve the accuracy of beamforming performed via the microphone array. For example, if a sound is detected by acoustic transducers 2520(C) and 2520(D) and the distance between acoustic transducers 2520(C) and 2520(D) is greater than, e.g., the distance between acoustic transducers 2520(D) and 2520(E), the determined source location of the detected sound may be more accurate than if the sound had been detected by acoustic transducers 2520(D) and 2520(E).

Controller 2525 of neckband 2505 may process information generated by the sensors on neckband 2505 and/or augmented-reality system 2500. For example, controller 2525 may process information from the microphone array that describes sounds detected by the microphone array. For each detected sound, controller 2525 may perform a direction-of-arrival (DOA) estimation to estimate a direction from which the detected sound arrived at the microphone array. As the microphone array detects sounds, controller 2525 may populate an audio data set with the information. In embodiments in which augmented-reality system 2500 includes an inertial measurement unit, controller 2525 may compute all inertial and spatial calculations from the IMU located on eyewear device 2502. A connector may convey information between augmented-reality system 2500 and neckband 2505 and between augmented-reality system 2500 and controller 2525. The information may be in the form of optical data, electrical data, wireless data, or any other transmittable data form. Moving the processing of information generated by augmented-reality system 2500 to neckband 2505 may reduce weight and heat in eyewear device 2502, making it more comfortable to the user.

Power source 2535 in neckband 2505 may provide power to eyewear device 2502 and/or to neckband 2505. Power source 2535 may include, without limitation, lithium ion batteries, lithium-polymer batteries, primary lithium batteries, alkaline batteries, or any other form of power storage. In some cases, power source 2535 may be a wired power source. Including power source 2535 on neckband 2505 instead of on eyewear device 2502 may help better distribute the weight and heat generated by power source 2535.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 2600 in FIG. 26, that mostly or completely covers a user's field of view. Virtual-reality system 2600 may include a front rigid body 2602 and a band 2604 shaped to fit around a user's head. Virtual-reality system 2600 may also include output audio transducers 2606(A) and 2606(B). Furthermore, while not shown in FIG. 26, front rigid body 2602 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 2500 and/or virtual-reality system 2600 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 2500 and/or virtual-reality system 2600 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 2500 and/or virtual-reality system 2600 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For example, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

Computing devices and systems described and/or illustrated herein, such as those included in the illustrated display devices, broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A camera system comprising:
a primary camera;
a plurality of secondary cameras that each have a maximum horizontal field of view (FOV) that is less than a maximum horizontal FOV of the primary camera, wherein:
two of the plurality of secondary cameras are positioned such that their maximum horizontal FOVs overlap in an overlapped horizontal FOV; and
the overlapped horizontal FOV is at least as large as a minimum horizontal FOV of the primary camera; and
an image controller that simultaneously activates two or more of the primary camera and the plurality of secondary cameras when capturing images from a portion of an environment included within the overlapped horizontal FOV.

2. The camera system of claim 1, wherein at least one of the primary camera and the plurality of secondary cameras comprises a fixed lens camera.

3. The camera system of claim 1, wherein the primary camera comprises a fisheye lens.

4. The camera system of claim 1, wherein the secondary cameras each have a greater focal length than the primary camera.

5. The camera system of claim 1, wherein the image controller is configured to digitally zoom at least one of the primary camera and the plurality of secondary cameras by:
receiving image data from the at least one of the primary camera and the plurality of secondary cameras; and
producing images that correspond to a selected portion of the corresponding maximum horizontal FOV of the at least one of the primary camera and the plurality of secondary cameras.

6. The camera system of claim 5, wherein, when the image controller digitally zooms the primary camera to a maximum extent, the corresponding image produced by the image controller covers a portion of the environment that does not extend outside the minimum horizontal FOV.

7. The camera system of claim 5, wherein the image controller is configured to digitally zoom the at least one of the primary camera and the plurality of secondary cameras to a maximum zoom level corresponding to a minimum threshold image resolution.

8. The camera system of claim 5, wherein the image controller is configured to digitally zoom between the primary camera and at least one secondary camera of the plurality of secondary cameras by:
receiving image data from both the primary camera and the at least one secondary camera simultaneously;
producing primary images based on the image data received from the primary camera when a zoom level specified by the image controller corresponds to an imaged horizonal FOV that is greater than the overlapped horizontal FOV; and
producing secondary images based on the image data received from the at least one secondary camera when the zoom level specified by the image controller corresponds to an imaged horizonal FOV that is not greater than the overlapped horizontal FOV.

9. The camera system of claim 5, wherein the image controller is configured to digitally pan horizontally between the plurality of secondary cameras when the images produced by the image controller correspond to an imaged horizonal FOV that is less than the overlapped horizontal FOV.

10. The camera system of claim 9, wherein the image controller pans horizontally between an initial camera and a succeeding camera of the two secondary cameras by:
receiving image data from both the initial camera and the succeeding camera simultaneously;
producing initial images based on the image data received from the initial camera when at least a portion of the imaged horizonal FOV is outside the overlapped horizontal FOV and within the maximum horizontal FOV of the initial camera; and
producing succeeding images based on the image data received from the succeeding camera when the imaged horizontal FOV is within the overlapped horizontal FOV.

11. The camera system of claim 1, further comprising a plurality of camera interfaces, wherein each of the primary camera and the two secondary cameras sends image data to a separate one of the plurality of camera interfaces.

12. The camera system of claim 11, wherein the image controller selectively produces images corresponding to one of the plurality of camera interfaces.

13. The camera system of claim 11, wherein:
each of the plurality of camera interfaces is communicatively coupled to multiple additional cameras; and
the image controller selectively activates a single camera connected to each of the plurality of camera interfaces and deactivates the remaining cameras at a given time.

14. The camera system of claim 1, further comprising a plurality of tertiary cameras that each have a maximum horizontal FOV that is less than the maximum horizontal FOV of the of each of the secondary cameras, wherein two of the plurality of tertiary cameras are positioned such that their maximum horizontal FOVs overlap in an overlapped horizontal FOV.

15. The camera system of claim 14, wherein:
the primary, secondary, and tertiary cameras are respectively included within primary, secondary, and tertiary tiers of cameras; and
the camera system further comprises one or more additional tiers of cameras that each include multiple cameras.

16. The camera system of claim 1, wherein an optical axis of the primary camera is oriented at a different angle than an optical axis of at least one of the secondary cameras.

17. The camera system of claim 1, wherein the primary camera and the plurality of secondary cameras may be oriented such that the horizontal FOV extends in a non-horizontal direction.

18. A camera system comprising:
a primary camera;
a plurality of secondary cameras that each have a maximum horizontal field of view (FOV) that is less than a maximum horizontal FOV of the primary camera, wherein two of the plurality of secondary cameras are positioned such that their maximum horizontal FOVs overlap; and
an image controller that simultaneously activates two or more of the primary camera and the plurality of secondary cameras when capturing images from a portion of an environment to produce a virtual camera image formed by a combination of image elements captured by the two or more of the primary camera and the plurality of secondary cameras.

19. The camera system of claim 18, wherein the image controller further:
detects at least one object of interest in the environment based on image data received from the primary camera;
determines a virtual camera view based on the detection of the at least one object of interest; and
generates the virtual camera image corresponding to the virtual camera view using image data received from at least one of the activated plurality of secondary cameras.

20. A method comprising:
receiving image data from a primary camera;
receiving image data from a plurality of secondary cameras that each have a maximum horizontal field of view (FOV) that is less than a maximum horizontal FOV of the primary camera, wherein:
two of the plurality of secondary cameras are positioned such that their maximum horizontal FOVs overlap in an overlapped horizontal FOV; and
the overlapped horizontal FOV is at least as large as a minimum horizontal FOV of the primary camera; and
simultaneously activating, by an image controller, two or more of the primary camera and the plurality of secondary cameras when capturing images from a portion of an environment included within the overlapped horizontal FOV.
